(19) United States
(12) Patent Application Publication
(10) Pub. No.: US 2016/0142315 A1
(43) Pub. Date: May 19, 2016

(54) TRANSMISSION APPARATUS, FORWARDING CONTROL METHOD, AND INFORMATION PROCESSING APPARATUS

(71) Applicant: FUJITSU LIMITED, Kawasaki-shi (JP)

(72) Inventors: Hiroshi Tomonaga, Kawasaki (JP); Atsushi Kitada, Kawasaki (JP); Mami Sekido, Kanagawa (JP)

(73) Assignee: FUJITSU LIMITED, Kawasaki-shi (JP)

(21) Appl. No.: 14/926,848

(22) Filed: Oct. 29, 2015

(30) Foreign Application Priority Data
Nov. 13, 2014 (JP) 2014-230779

(51) Int. Cl. H04L 12/743

(52) U.S. Cl. CPC H04L 45/7453

(57) ABSTRACT

A plurality of hash values is obtained by using a plurality of hash functions based on identification information of input data. A forwarding of the input data is controlled with reference to forwarding information based on any one of the hash values. A selection of a hash value to be used for the reference based on hash management information is controlled. The hash management information indicates whether or not each of the hash values is in-use to refer the forwarding information for each hash function.

### CROSS-REFERENCE TO RELATED APPLICATION

This application is based upon and claims the benefit of priority of the prior Japanese Patent application No. 2014-230779, filed on Nov. 13, 2014, the entire contents of which are incorporated herein by reference.

### FIELD

The embodiments discussed here are related to a transmission apparatus, a forwarding control method, and an information processing apparatus.

### BACKGROUND

A packet transmission apparatus such as a router or a switch refers and searches a forwarding table based on a destination address of a received packet to determine a forwarding destination of the received packet.

### Patent Documents List

Patent Document 1: JP 3-54937 A

Patent Document 2: JP 2013-179421 A

Patent Document 3: JP 2010-50600 A

Patent Document 4: JP 2009-123050 A

Patent Document 5: JP 2004-227434 A

When the number of destination addresses of packets is increased, a forwarding table becomes upsized. In many cases, the number of destination addresses of the packets possibly received by the packet transmission apparatus would be smaller than all of the number of addresses representable by the number of bits of the destination address.

Therefore, the destination address is converted into a hash value in an address space degenerated by a hash function, and the obtained hash value is used for a reference (or search) key of the forwarding table. Thereby, it is possible to suppress the forwarding table from being upsized.

However, when the destination address space is degenerated by using the hash function, the same hash values may be obtained with respect to different destination addresses. Upon occurring such a collision of the hash values, it would be unavailable to determine a correct forwarding destination of a packet by a single reference (or search) of the forwarding table. In other words, the number of times of references (or searches) of the forwarding table would increase. Therefore, there is a possibility that the forwarding performance of the packet transmission apparatus is deteriorated.

### SUMMARY

According to an aspect, a transmission apparatus may include: a hash calculator configured to obtain a plurality of hash values by using a plurality of hash functions based on identification information of input data; a forwarding controller configured to control a forwarding of the input data with reference to forwarding information based on any one of the hash values; and a hash controller configured to control a selection of a hash value to be used for the reference based on hash management information, the hash management information indicating whether or not each of the hash values is in-use to refer the forwarding information for each hash function.

Further, according to an aspect, a forwarding control method may include: obtaining a plurality of hash values by using a plurality of hash functions based on identification information of input data; controlling a forwarding of the input data with reference to forwarding information based on any one of the hash values; and controlling a selection of a hash value to be used for the reference based on hash management information, the hash management information indicating whether or not each of the hash values is in-use to refer the forwarding information for each hash function.

Furthermore, according to an aspect, an information processing apparatus may include: a hash calculator configured to obtain a plurality of hash values by using a plurality of hash functions based on identification information of input data; an information searcher configured to search information corresponding to the input data with reference to a database in which information corresponding to the identification information is registered; and a hash controller configured to control a selection of a hash value to be used for the reference based on hash management information, the hash management information indicating whether or not each of the hash values is in-use to refer the database for each hash function.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an exemplary configuration of a packet transmission apparatus according to an embodiment;

FIG. 2 is a diagram schematically illustrating an example of referring a forwarding table with a hash value obtained by a hash calculation on a MAC address by using a hash function;

FIG. 3 is a diagram schematically illustrating an example using a plurality of hash functions in FIG. 2;

FIG. 4 is a schematic diagram to explain an example of a hash value management and MAC address registration process according to an embodiment;

FIG. 5 is a diagram illustrating an example of a hash management table according to an embodiment;

FIG. 6 is a diagram illustrating an entry deletion (or update) process of a hash management table in response to a deletion of a registered MAC address according to an embodiment;

FIG. 7 is a diagram illustrating an entry deletion (or update) process of a hash management table in response to a deletion of a registered MAC address according to an embodiment;

FIG. 8 is a diagram illustrating an entry deletion (or update) process of a hash management table in response to a deletion of a registered MAC address according to an embodiment;

FIGS. 9A to 9D are diagrams illustrating an exemplary process (first exemplary process) when a collision is occurred in hash values, according to an embodiment;

FIGS. 10A to 10D are diagrams illustrating an exemplary process (second exemplary process) when a collision is occurred in hash values, according to an embodiment;

FIGS. 11A to 11D are diagrams illustrating an exemplary process (third exemplary process) when a collision is occurred in hash values, according to an embodiment;

FIG. 12 is a diagram illustrating an exemplary processing of a collision in hash values by using a multi-staged hash function without upsizing a forwarding table, according to an embodiment;

FIG. 13 is a diagram illustrating an exemplary process when a plurality of second-stage hash functions is provided in FIG. 12;

FIG. 14 is a diagram illustrating an exemplary process when a first-stage hash function is updated in FIG. 12;

FIG. 15 is a diagram illustrating an exemplary collision process by using both of a CAM and a pointer table in FIG. 4;

FIGS. 16A and 16B are diagrams illustrating an exemplary calculation of a hash value;

FIGS. 17A and 17B are diagrams illustrating an exemplary effect of an embodiment;

FIG. 18 is a block diagram illustrating a first exemplary configuration of the packet transmission apparatus illustrated in FIG. 1;

FIG. 19 is a flowchart illustrating an exemplary operation (e.g., at the time of destination reference) of a forwarding processor illustrated in FIG. 18;

FIG. 20 is a flowchart illustrating an exemplary operation (e.g., at the time of address registration) of a forwarding processor illustrated in FIG. 18;

FIG. 21 is a flowchart illustrating an example of a registration condition determination process illustrated in FIG. 20;

FIG. 22 is a flowchart illustrating an example of a collision determination process illustrated in FIG. 20;

FIG. 23 is a flowchart illustrating an example of an update process of a hash management table by a hash management table controller illustrated in FIG. 18;

FIG. 24 is a flowchart illustrating an exemplary operation (e.g., at the time of releasing address registration) of a forwarding processor illustrated in FIG. 18;

FIG. 25 is a block diagram illustrating a second exemplary configuration of the packet transmission apparatus illustrated in FIG. 1;

FIG. 26 is a flowchart illustrating an exemplary operation (e.g., at the time of address registration) of a forwarding processor illustrated in FIG. 25;

FIG. 27 is a flowchart illustrating an example of a hash function search process illustrated in FIG. 26;

FIG. 28 is a flowchart illustrating an example of a hash function search process illustrated in FIG. 26;

FIG. 29 is a flowchart illustrating an exemplary operation (e.g., at the time of updating a first hash function) of a forwarding processor illustrated in FIG. 25;

FIG. 30 is a block diagram illustrating an exemplary configuration of the packet transmission apparatus illustrated in FIG. 1; and

FIG. 31 is a block diagram illustrating another exemplary configuration of the packet transmission apparatus illustrated in FIG. 1.

### DESCRIPTION OF EMBODIMENTS

Hereinafter, embodiments of the present invention will be described with reference to the drawings. The embodiments described below are merely examples and are not intended to exclude application of various modifications or technologies that are not explicitly described below. In addition, various exemplary embodiments to be described below may be carried out in combination as appropriate. In the drawings referred in the embodiments described below, parts to which the same reference numeral is assigned denote same or similar parts unless otherwise mentioned.

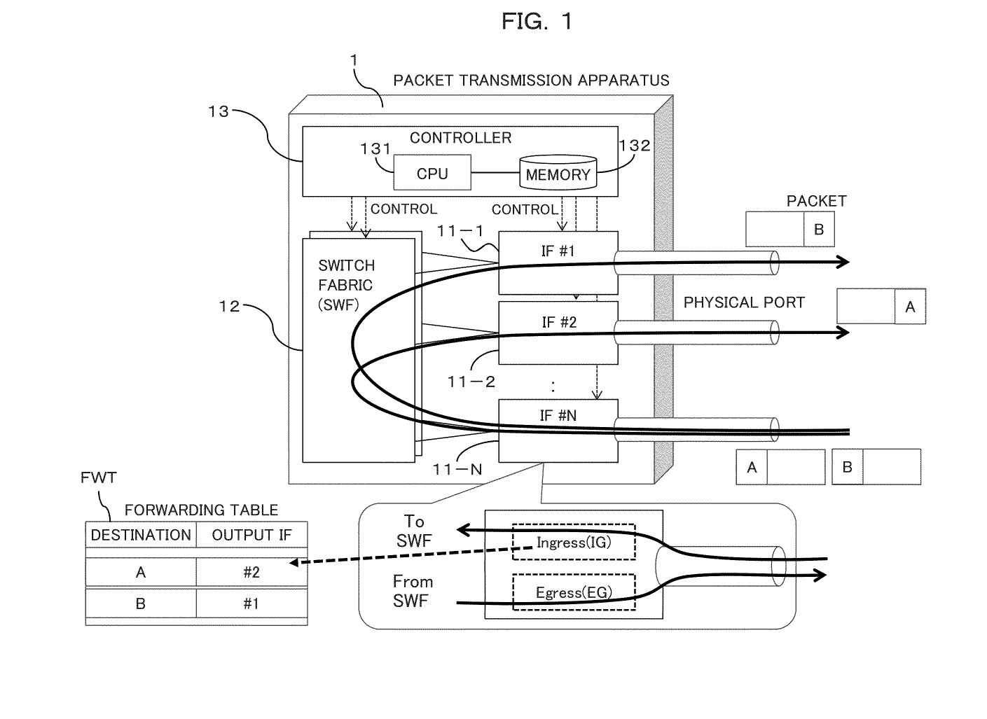

FIG. 1 is a block diagram illustrating an exemplary configuration of a packet transmission apparatus according to an embodiment. The packet transmission apparatus 1 is operable to output packet data (hereinafter, may simply be referred to as “packet”), which is received through any one of ports, to a port corresponding to destination information included in the received packet. The “packet” is an example of a communication signal and may include a user signal or a control signal. The “signal” may be read as “data” or “information”.

An example of the destination information may be information available to identify a communication device which is a destination of a packet, or to identify a route or path reachable to the corresponding destination. An example of such identification information may be address information such as a MAC address or an IP address. The “MAC” is an abbreviation of “Media Access Control”, and the “IP” is an abbreviation of “Internet Protocol”.

The packet output to the port corresponding to the destination information may be referred to as “transmission”, “forwarding”, or “switch” of the packet. Therefore, the packet transmission apparatus 1 may be referred to as a “packet router” or a “packet switch”.

The forwarding of the packet may be performed based on, for example, destination information of the received packet and a database with table-format in which destination information and path information are associated with each other. The database may be called a forwarding table or a transmission table. The path information may include, for example, information available to identify an output port of the packet transmission apparatus 1.

The packet transmission apparatus 1 illustrated in FIG. 1 may include, for example, N input-output interfaces (IFs) 11-1 to 11-N (#1 to #N) (where N is an integer equal to or greater than 1), a switch fabric (SWF) 12, and a controller 13.

In the following, when it is unnecessary to distinguish the input-output IFs 11-i (#i) (i=any one of 1 to N) each other, the input-output IFs 11-i (#i) may be simply referred to as “input-output IFs 11”. In addition, the packet transmission apparatus 1 may be simply referred to as a “transmission apparatus 1”.

The input-output IF 11 includes, for example, one or more of input ports and output ports, and is operable to transmit and receive a packet through a corresponding input port or output port. An input side of the input-output IF 11 may be referred to as “IG (Ingress)”, and an output side of the input-output IF 11 may be referred to as “EG (egress)”.

The SWF 12 connects any of the input-output IFs 11 to form (may be referred to as “set”) an internal packet transmission path according to the control of the controller 13. The SWF 12 may be plurally provided according to the number of the input-output IFs 11 (in other words, the number of the input ports and the output ports) provided in the packet transmission apparatus 1.

The input-output IF 11 includes, for example, a forwarding table FWT. The input-output IF 11 refers and searches the forwarding table FWT based on the destination information of the packet received at the IG to identify and determine an input-output IF 11 to which the received packet is to be transmitted. The reference and search of the forwarding table FWT may be referred to as “access” to the forwarding table FWT.

The forwarding table FWT is an example of forwarding information represented by table-format information (or data). In the example of FIG. 1, the forwarding table FWT of the input-output IF 11 #N includes forwarding information indicating that a packet with destination information A is transferred to the input-output IF #2 and that a packet with destination information B is transferred to the input-output IF #1. For descriptive purposes, the packet with the destination information A and the packet with the destination information B may be referred to as “packet A” and “packet B”, respectively.

Upon receiving the packet A, the input-output IF #N determines to transfer the received packet A to the input-output IF #2 with reference to the forwarding table FWT based on the destination information A.

Similarly, upon receiving the packet B, the input-output IF #N determines to transfer the received packet B to the input-output IF #1 with reference to the forwarding table FWT based on the destination information B.

The above determination may be referred to as “destination determination” or “destination identification”. The access to the forwarding table FWT for the “destination determination” may be referred to as “destination reference” or “destination search”.

The destination identification result in the input-output IF 11 may be provided to the controller 13, for example. The controller 13 controls the SWF 12 based on the destination identification result to set an internal transfer path corresponding to the destination information of the received packet between the corresponding input-output IFs 11. Accordingly, the received packet is transferred to an appropriate input-output IF 11 corresponding to the destination information included in the received packet.

In the example of FIG. 1, the identification information of the input-output IF 11 (for example, IF number #i) is registered in the forwarding table FWT as an example of the internal forwarding destination information. However, for the input-output IF 11 having a plurality of input ports and output ports, identification information of the input ports and the output ports may be registered.

The controller 13 is operable to integrally control the entire operation of the packet transmission apparatus 1. For example, the controller 13 is available to control the operation of the input-output IF 11 and the operation of the SWF 12. In other words, the controller 13 is available to transceive a control signal between the input-output IF 11 and the SWF 12. For example, the control of the input-output IF 11 may include a process of setting or updating the forwarding table FWT.

As illustrated in FIG. 1, the controller 13 may be realized by using a central processing unit (CPU) 131 and a memory 132. The CPU 131 is an example of a processor having computing capability and may be referred to as a processor device or a processor circuit.

The memory 132 is an example of a storage device or a storage medium and may be a random access memory (RAM) or a hard disk drive (HDD). The memory 132 may correspond to a part of a storage area of the RAM or the HDD.

The configuration of the transmission apparatus 1 is not limited to the configuration illustrated in FIG. 1. For example, the forwarding table FWT may be provided in a common portion of the transmission apparatus 1 such as the SWF 12. In addition, the transmission apparatus 1 may be configured such that function blocks are detachable like “chassis type”, and may be configured such that function blocks are integrated like “pizza box type”.

In the following embodiment, as described above, the reduction in the size of the forwarding table FWT referred at the time of transferring the received packet or the reduction in the number of reference times (in other words, the number of access times) will be described.

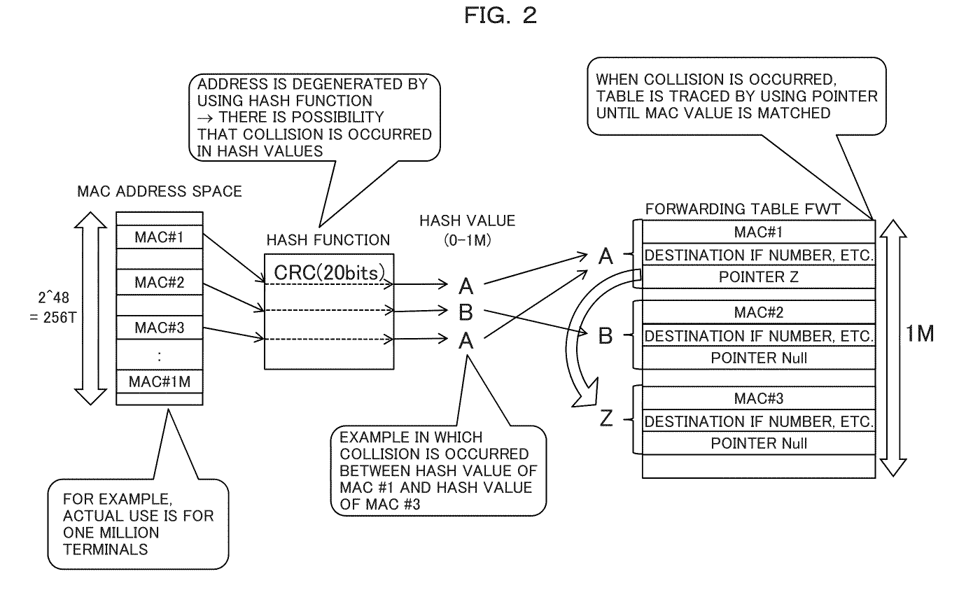

First, in an Ethernet switch that is an example of the transmission apparatus 1, an example of hash-searching a MAC address registered in the forwarding table FWT will be described with reference to FIG. 2. The “Ethernet” is the registered trademark.

A MAC address space in the Ethernet is 48 bits. Thus, when the forwarding table FWT of all addresses representable by 48 bits is prepared, a huge address space of 2⁴⁸=256 tera (T) bits is required.

However, the number of MAC addresses of the packets actually processed by the packet transmission apparatus 1 is not all of the number of MAC addresses representable by 48 bits, but may be limited to a part thereof. Therefore, the transmission apparatus 1 may use a method of converting a destination MAC address of a received packet into a hash value of an address space degenerated by a hash function and referring the forwarding table FWT with the obtained hash value.

For example, it is assumed that the number of the MAC addresses available to be actually processed by the packet transmission apparatus 1 is the number of addresses of one million communication devices. Under the above assumption, as illustrated in FIG. 2, a 20-bit CRC (hereinafter, may be referred to as “CRC20”) as an example of the hash function is used to degenerate the MAC address to about one million (1 M) hash values representable by 20 bits.

However, the “hash function” is also referred to as “summarization function” and is merely to distribute (may also be referred to as “map” or “assign”) input information in a limited amount of information. Therefore, with the hash function, the same hash values may be accidentally assigned to different MAC addresses. This may be referred to as “collision” or “reduplication” of the hash value.

In the example of FIG. 2, a hash value A of the MAC address MAC#1 and a hash value A of the MAC address MAC#3 are in a collision. In FIG. 2, a hash value B represents a hash value of the MAC address MAC#2.

Even when the collision is occurred in the hash values, for example, pointer information may be used to enable the packet forwarding corresponding to the original MAC address. For example, as illustrated in FIG. 2, pointer information in addition to the MAC address and the destination IF number is held for each entry in the forwarding table FWT having an entry for each hash value.

The pointer information is, for example, information indicative of a next search candidate entry when MAC addresses are not matched in the entry for each hash value of the forwarding table FWT. When no next search candidate entry is exists, a “Null” may be set to the pointer information.

In the example of FIG. 2, pointer information Z is set to an entry corresponding to the hash value A in the forwarding table FWT. The pointer information Z is information indicative of an entry corresponding to a hash value Z (in other words, entry of the MAC address MAC#3).

Upon referring the forwarding table FWT based on the hash value A of the MAC address MAC#1, the MAC addresses are matched with each other because the MAC address MAC#1 is registered in the entry of the hash value A. When the MAC addresses are matched with each other, the forwarding destination of the received packet is identified and determined based on the “destination IF number” or the like registered in the corresponding entry.

Regarding the hash value B of the MAC address MAC#2, since the MAC addresses are matched with each other in the entry corresponding to the hash value B in the forwarding table FWT, the forwarding destination of the received packet is identified and determined based on the “destination IF number” or the like registered in the corresponding entry.

Meanwhile, regarding the hash value A of the MAC address MAC#3 in which a collision is occurred, upon referring the forwarding table FWT, the MAC addresses are not matched because the different MAC address MAC#1 is registered in the entry of the hash value A.

Therefore, the next search candidate entry (for example, the entry of the hash value Z) is referred based on the pointer information Z set to the corresponding entry. Since the MAC address MAC#3 is registered in the entry of the hash value Z, the MAC addresses are matched. Therefore, the forwarding destination of the received packet is identified and determined based on the “destination IF number” or the like registered in the corresponding entry.

When a collision is occurred in the hash values, the access to the forwarding table FWT is repeated based on the pointer information until the entry matched with the MAC address is found.

Therefore, the access to the forwarding table FWT would be occurred as many as the number of times corresponding to the number of collisions of the hash values up to the maximum. As a result, as the number of collisions in the hash values increases, the number of the accesses to the forwarding table FWT increases and the performance of the packet forwarding (hereinafter, may be referred to as “forwarding performance”) may be deteriorated.

By increasing the number of the forwarding tables FWT according to a probability of collision in hash values, the forwarding performance may be improved, but the consumption of hardware resources would increase. Moreover, the number of the accesses to the forwarding table FWT would be unchanged (or not reduced).

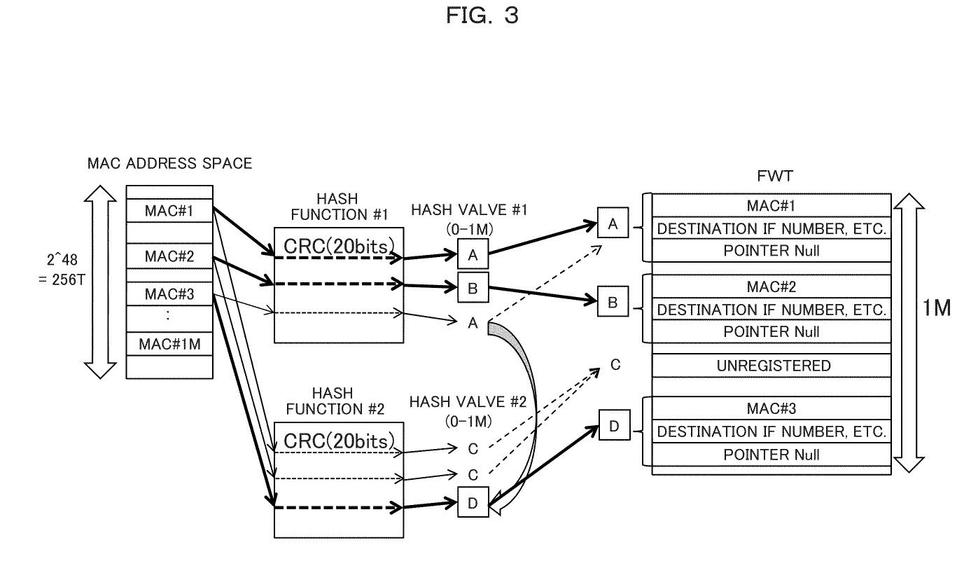

Therefore, in order to prevent the forwarding performance from being deteriorated without increasing the hardware resources, it is effective to lower the probability of collision in the hash values as far as possible. An example of a method of lowering the probability of collision in the hash values is a method using a plurality of hash functions (see FIG. 3).

FIG. 3 illustrates an example using two hash functions #1 and #2. FIG. 3 illustrates an exemplary case where both of the hash functions #1 and #2 degenerate the MAC address by using the CRC20 . However, the number of bits of the CRC used in the hash functions #1 and #2 may be different from each other.

First, in a case where the hash value #1 is obtained by using one hash function #1 and a collision is not occurred, the forwarding table FWT is referred and searched with the hash value #1 as in the case of using a single hash function as illustrated in FIG. 2.

For example, the hash value #1=A obtained by the hash function #1 is selected for the MAC address MAC#1, and the forwarding table FWT is referred and searched with the hash value A as a search key.

Similarly, for the MAC address MAC#2, the hash value #1=B obtained by the hash function #1 is selected, and the forwarding table FWT is referred and searched with the hash value B as a search key.

Meanwhile, in a case where a collision is occurred in the hash values, the hash value #2 is obtained by using the other hash function #2. When a collision is not occurred in the hash value #2, the hash value #2 of the hash function #2 is selected as the search key of the forwarding table FWT.

For example, in FIG. 3, when the hash value #1=A is obtained by the hash function #1 for the MAC address MAC#3, the hash value A collides with the hash value #1=A of the MAC address MAC#1. When the collision is occurred in the hash value A, the hash function #1 is not selected and the hash function #2 is selected.

Here, in the example of FIG. 3, the hash value #2 obtained by the hash function #2 is “D” and does not collides with the hash value #1 (A and B) obtained by the hash function #1. Therefore, the hash value #2=D obtained by the hash function #2 is selected and used as the search key of the forwarding table FWT.

In this way, by hierarchically using the plurality of hash functions, it is possible to reduce the probability of collision in the hash values.

However, in the example of FIG. 3, when considering the process upon an arrival of the packet, it is unavailable to identify which one of the hash functions #1 and #2 has been selected. For example, since the hash values of the MAC address MAC#1 and the MAC address MAC#3 are all “A”, it is unavailable to identify which one of the hash functions #1 and #2 is to be selected by only referring the hash value #1. The same also applies to the hash value #2.

Therefore, it results in obtaining the hash values #1 and #2 by using both of the hash functions #1 and #2 and referring the forwarding table FWT with the hash values #1 and #2 to select the entry having the matched MAC address, as illustrated in FIG. 1.

As a result, the accesses to the forwarding table FWT is occurred up to the maximum number of the hash functions, and the forwarding performance may be deteriorated. In other words, as the number of the hash functions is increased so as to lower the probability of collision in the hash values, the number of access times to the forwarding table FWT is increased. Therefore, the forwarding performance may be deteriorated significantly. Hence, even when the probability of collision in the hash values is lowered, it may be unavailable to suppress the deterioration of the forwarding performance.

In the present embodiment, the deterioration of the forwarding performance is suppressed as much as possible. For example, a plurality of hash functions is prepared and a priority (may also be referred to as “priority rank”) is assigned to each of the hash function.

The priority may be different between the time of MAC address registration to the forwarding table FWT and the time of destination reference (may also be referred to as “destination search”) in the forwarding table FWT.

For example, in the case of using two hash functions, the priority assigned to each hash function may be reversed at the time of the MAC address registration and at the time of the destination search. The priority at the time of the address registration may be referred to as “address registration priority”, and the priority at the time of the destination reference may be referred to as “destination reference priority”.

In the case of using three or more hash functions, for example, the “destination reference priority” may be set in descending order of the hash function numbers, and the “address registration priority” may be set in ascending order of the hash function numbers. Alternatively, to the contrary, the “address registration priority” may be set in descending order of the hash function numbers, and the “destination reference priority” may be set in ascending order of the hash function numbers.

In addition, a hash management table (HMT) may be prepared, and information (may also be referred to as “flag information”) indicating which one of the hash functions is in-use may be registered in the hash management table. The hash management table is an example of hash management information represented as table-format information (or data).

When a collision is occurred in the hash values, a plurality of flag information is enabled in the hash management table. For example, the flag information may be a bit of “1” or “0” and may indicate “enable” by “1” and “disable” by “0”. In this case, in the hash management table, which one of the hash functions is in-use can be indicated by a bit pattern (may also be referred to as a “bitmap”).

The in-use hash function can be identified based on the pattern of the flag information, and the hash value can be selected based on the identification result and the priority at the time of the destination reference. In addition, at the time of a subsequent MAC address registration, in order to prevent the pattern of the flag information from being changed, whether or not the subsequent MAC address is allowed to be registered may be determined.

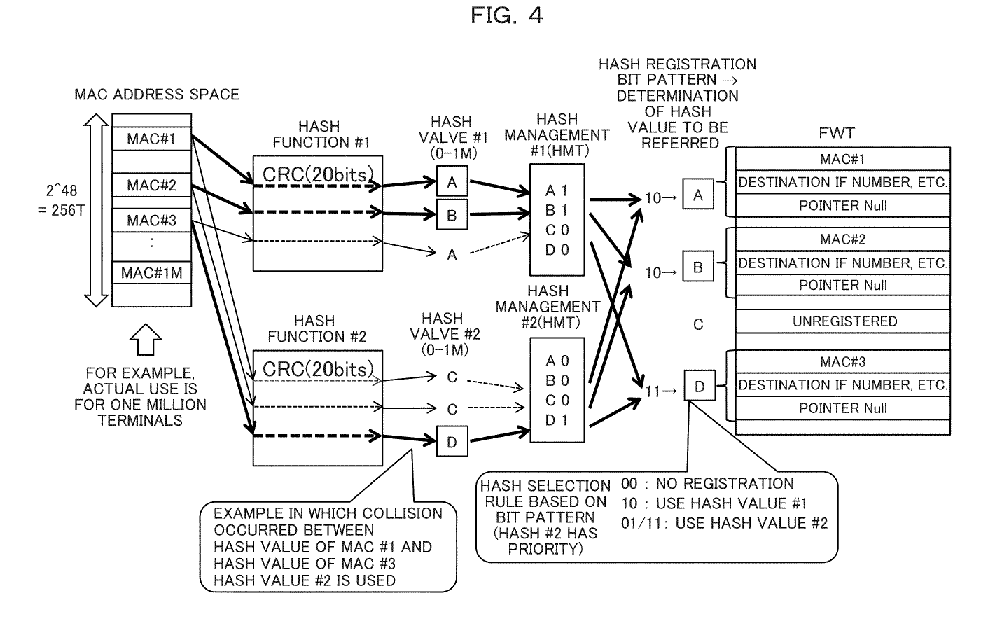

Hereinafter, as described above, an example of a management of the hash value and a registration of the MAC address by using the plurality of hash functions and the hash management table will be described with reference to FIG. 4.

Although the following descriptions are given to the processes for the MAC address, the processes described below are applicable to other destination information such as IP address, MPLS label, VLAN tag, and the like. The “MPLS” is an abbreviation of “Multi-Protocol Label Switching”, and the “VLAN” is an abbreviation of “Virtual Local Area Network”.

In the example of FIG. 4, each of two hash functions #1 and #2 may be CRC20 as in the example of FIG. 3 and are available to degenerate the MAC address space of 256T bits to the hash value of 1 M (mega) bits.

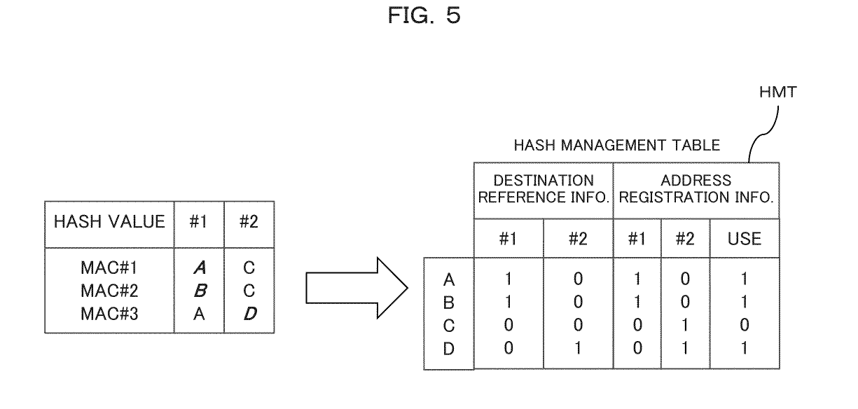

Here, the priorities are assigned such that the hash function #1 is preferentially select at the time of the MAC address registration and the hash function #2 is preferentially selected at the time of the destination reference. In addition, the hash management table HMT as illustrated on the right side of FIG. 5 is prepared.

For example, the information (for example, the flag information) indicating which one of the hash functions is in-use for each hash value may be registered in the hash management table HMT.

In the example of FIG. 4, for the MAC address MAC#1, the hash value #1=A is obtained by the hash function #1 and the hash value #2=C is obtained by the hash function #2.

Meanwhile, for the MAC address MAC#2, the hash value #1=B is obtained by the hash function #1 and the hash value #2=C is obtained by the hash function #2.

Further, for the MAC address MAC#3, the hash value #1=A is obtained by the hash function #1 and the hash value #2=D is obtained by the hash function #2.

A table illustrated on the left side of FIG. 5 represents the hash values A to D obtained by the hash functions #1 and #2 for each of the MAC addresses MAC#1 to MAC#3 as described above in the table-format data.

Based on the above table, in the hash management table HMT illustrated on the right side of FIG. 5, which one of the hash functions #1 and #2 is selected and used can be managed for each hash value.

For example, it is assumed that three packets of the MAC addresses MAC#1 to MAC#3 arrive at the packet transmission apparatus 1 in the order of MAC#1 to MAC#3 when the MAC addresses MAC#1 to MAC#3 are not yet registered in the forwarding table FWT.

Under this assumption, the hash function #1 is preferentially selected first for the MAC address MAC#1 having arrived earliest. In the example of FIG. 4, the hash value #1 obtained by the hash function #1 is “A”.

Therefore, in the hash management table HMT of FIG. 5, “1” of the flag information for the hash value #1=A obtained by the hash function #1 is set and registered as “destination reference information”. The “destination reference information” may be referred to as the “destination reference table”.

In addition, as illustrated in FIG. 4, information such as the MAC address MAC#1 and the destination IF number may be registered in the entry A corresponding to the hash value A of the forwarding table FWT in response to the selection of the hash value #1=A.

The “address registration information” in the hash management table HMT of FIG. 5 will be described later. The “address registration information” may be referred to as “address registration table”. In addition, the “hash management #1” illustrated in FIG. 4 corresponds to the flag information of the hash function #1 (or hash value #1), which is represented in and extracted from the entry of the first column of the “destination reference information” in the hash management table HMT of FIG. 5.

Similarly, the “hash management #2” illustrated in FIG. 4 corresponds to the flag information of the hash function #2 (or hash value #2), which is represented in and extracted from the entry of the second column of the “destination reference information” in the hash management table HMT of FIG. 5.

For the MAC address MAC#2 of the subsequently arrived packet, the hash function #1 is also preferentially selected first.

In the example of FIG. 4, the hash value #1 obtained by the hash function #1 is “B”.

The hash value #1=B does not collide with the hash value #1=A for the MAC address MAC#1. In other words, the flag information for the hash value #1=B is “0” in the hash management table HMT illustrated in FIG. 5.

Therefore, the selection of the hash value #1=B for the MAC address MAC#2 is determined, and the flag information for the hash value #1=B obtained by the hash function #1 is set to “1” in the “destination reference information” of the hash management table HMT illustrated in FIG. 5.

As illustrated in FIG. 4, information such as the MAC address MAC#2 and the destination IF number may be registered in the entry B corresponding to the hash value B of the forwarding table FWT in response to the selection of the hash value #1=B.

Further, for the MAC address MAC#3 of the packet subsequently arrived after the packet of the MAC address MAC#2, the hash function #1 is also preferentially selected first. The hash value #1 obtained by the hash function #1 is “A”.

Here, since the flag information has already been set to “1” in the hash management table HMT, it is determined that a collision is occurred in the hash values #1=A.

Therefore, for the MAC address MAC#3, the hash function #2 having the next priority is a selection candidate. In the example of FIG. 4, the hash value #2 obtained by the hash function #2 is “D”.

The hash value #2=D does not collide with the hash values #1 (A and B) for the MAC address MAC#1 and MAC#2 having already been arrived. In other words, the flag information for the hash value #2=D is “0” in the hash management table HMT illustrated in FIG. 5.

Therefore, the selection of the hash value #2=D for the MAC address MAC#3 is determined, and the flag information for the hash value #2=D obtained by the hash function #2 is set to “1” in the “destination reference information” of the hash management table HMT illustrated in FIG. 5.

As illustrated in FIG. 4, information such as the MAC address MAC#3 and the destination IF number may be registered in the entry D corresponding to the hash value D of the forwarding table FWT in response to the selection of the hash value #2=D.

As described above, at the time of the MAC address registration, the hash function #1 is preferentially used, and the hash value #1 not generating a collision (in other words, not in-use) is selected.

When a collision with the selected hash value #1 (whose flag information is 1) is occurred, the hash function #2 having the next priority is selected, and the hash value #2 not generating a collision (in other words, not in-use) is selected.

In response to the selection of the hash value, the information such as the MAC address and the destination IF number is registered in the entry corresponding to the selected hash value of the forwarding table FWT.

After the MAC addresses are registered in the forwarding table FWT Next as described above, it is assumed that another packet having the same MAC address registered in the forwarding table FWT arrives at the transmission apparatus 1. The forwarding process performed on the other packet will be described.

In this case, it is available to identify which one of the hash functions #1 and #2 is to be used based on the bit pattern of the “destination reference information” in the hash management table HMT illustrated in FIG. 5.

For example, it is determined (or identified) that the hash function #1 is to be used by the bit pattern=[10] of (hash value #1:hash value #2) and that the hash function #2 is to be used by the bit pattern=[01] or [11]. The bit pattern=[00] indicates “unregistered”.

When another packet assigned with the MAC address MAC#1 arrives at the transmission apparatus 1, (hash value #1:hash value #2)=(A:C) is obtained by the hash functions #1 and #2.

Upon referring the “destination reference information” in the hash management table HMT illustrated in FIG. 5 by using the hash values A and C as a key, the bit pattern of (A:C)=[10] is obtained.

Since the bit pattern=[10], the hash function #1 (in other words, hash value #1=A) is selected, and the entry A of the forwarding table FWT is referred by using the hash value #1=A as a key. Therefore, the destination IF number and the like for the packet with the MAC address MAC#1 is identified.

Meanwhile, when the packet with the MAC address MAC#2 arrives, (hash value #1:hash value #2)=(B:C) is obtained by the hash functions #1 and #2.

Upon referring the “destination reference information” in the hash management table HMT illustrated in FIG. 5 by using the hash values B and C as a key, the bit pattern of (B:C)=[10] is obtained.

Since the bit pattern=[10], the hash function #1 (in other words, hash value #1=B) is selected, and the entry B of the forwarding table FWT is referred by using the hash value #1=B as a key. Therefore, the destination IF number and the like for the packet with the MAC address MAC#2 is identified.

When the packet with the MAC address MAC#3 arrives, (hash value #1:hash value #2)=(A:D) is obtained by the hash functions #1 and #2.

Upon referring the “destination reference information” in the hash management table HMT illustrated in FIG. 5 by using the hash values A and D as a key, the bit pattern of (A:D)=[11] is obtained.

Since the bit pattern=[11], the hash function #2 (in other words, hash value #2=D) is selected, and the entry D of the forwarding table FWT is referred by using the hash value #2=D as a key. Therefore, the destination IF number and the like for the packet of the MAC address MAC#3 is identified.

In this way, by using the hash management table HMT to identify and select the hash function to be used, even when the collision in the hash values (for example, A), it is possible to suppress the number of times of the reference to the forwarding table FWT to one time.

However, in the case where the registration for the hash management table HMT is performed under the rule as described above, there is a possibility to erroneously select the hash function at the time of destination reference. For example, in the above-described example, since the hash function to be used is selected based on the bit pattern, when the bit pattern is changed in a subsequent address registration, there is a possibility that a correct selection of the hash function may be unavailable.

For example, it is assumed that the hash values #1 and #2 obtained by the hash functions #1 and #2 for a MAC address MAC#4 are the hash value #1=A and the hash value #2=C, respectively.

In this case, the hash value #1=A in the “destination reference information” of the hash management table HMT has been selected (in other words, in-use) because the flag information is 1. Therefore, the hash value #2=C is a selection candidate.

However, in the “destination reference information” in the hash management table HMT, if “1” is set and registered as the flag information of the hash value #2=C, the bitmaps for both of the MAC addresses MAC#1 and MAC#4 are “11”.

Therefore, there is the possibility that the hash value #1=C is erroneously selected for the MAC address MAC#1. When the hash value is erroneously selected, the MAC address is not matched in the reference entry of the forwarding table FWT. Hence, the MAC address MAC#1 may be erroneously determined as being “unregistered”.

As another example, it is assumed that the hash values #1 and #2 obtained by the hash functions #1 and #2 for another MAC address MAC#5 are the hash value #1=C and the hash value #2=D.

In this case, the hash value #1=C of the “destination reference information” in the hash management table HMT indicates “unused” because the flag information is 0. Therefore, the hash value #1=C is a selection candidate.

However, the hash value #2=D is in-use for the MAC address MAC#3. In other words, in the “destination reference information” of the hash management table HMT, “1” has already been registered as the flag information for the hash value #2=D.

Therefore, if “1” is registered to the “destination reference information” as each flag information for the hash value #1=C and the hash value #2=D, the bitmap for the MAC address MAC#5 is the same “11” as that for the MAC address MAC#3.

As a result, there is the probability that the hash value #2=D is erroneously selected for the MAC address MAC#3. Therefore, since the MAC address is not matched in the reference entry of the forwarding table FWT, the MAC address MAC#3 may be erroneously determined as being “unregistered”.

In view of the above, a MAC address which causes a collision in the bit patterns of the hash values #1 and #2 in the hash management table HMT may be determined as a “collision” and may be inhibited in the registration to the hash management table HMT.

In order to inhibit the registration of the colliding bit patterns to the “destination reference information”, the “address registration information” may be held in the hash management table HMT in addition to the “destination reference information” as illustrated on the right side of FIG. 5.

For example, for all of the MAC addresses registered in the forwarding table FWT, flag information that is an example of information indicative of the presence or absence of the entry corresponding to the hash values #1 and #2 for each of the hash functions #1 and #2 may be registered in the “address registration information”. In other words, the flag information may be registered for all of the MAC addresses, regardless of use or non-use (in other words, selected or unselected) of the hash values #1 and #2.

Further, for all of the hash value #1 or #2 corresponding to the selected hash function #1 or #2, information indicative of “in-use” (e.g., 1) or “not in-use” (e.g., 0) (hereinafter, may be referred to as “use flag”) may be registered in the “address registration information”.

With referring the “address registration information”, it is possible to inhibit the registration of the colliding bit patterns to the “destination reference information”. Hence, it is possible to achieve a correct selection of the hash values #1 and #2.

For example, in the example of FIG. 4, it is assumed that four packets with the MAC addresses MAC#4 to MAC#7 arrive at the packet transmission apparatus 1.

Here, it is also assumed that the hash value #1=A and the hash value #2=C are obtained for the MAC address MAC#4. In this case, the hash value #1=A of the hash function #1 is not a registration candidate (in other words, the hash value #1=A of the hash function #1 is excluded from the registration candidates) because “1” of the flag information is registered in the “address registration information”.

Similarly, the flag the hash value #2=C of the hash function #2 is not a registration candidate because “1” of the flag information is registered in the “address registration information”. Therefore, the registration of the hash valves #1 and #2 of the MAC address MAC#4 to the “destination reference information” is determined as being “unavailable for registration”.

In the example of FIG. 5, with respect to the hash valve C in the “destination reference information”, the flag information for both of the hash values #1 and #2 are “0” indicating “unused”. Therefore, it could be determined as being “allowed for registration”.

However, if the flag information for the hash value #2=C in the “destination reference information” is set and registered as “1”, the bitmaps of the hash values #1 and #2 for both of the MAC addresses MAC#1 and MAC#2 are changed to “11” as described above. Therefore, it is determined as being “unavailable for registration”.

Meanwhile, it is assumed that the hash value #1=C and the hash value #2=D are obtained for the MAC address MAC#5. In this case, the flag information corresponding to the hash value #1 in the “address registration information” is “0” and the use flag is also “0” indicating “unused”. Therefore, the hash value #1=C obtained by the hash function #1 is a registration candidate.

However, with respect to the hash value #2=D obtained by the hash function #2, “1” is registered as the flag information corresponding to the hash value #2 in the “address registration information”. As a result, the hash value #1=C is finally excluded (in other words, withdrawn) from the registration candidates.

Consequently, the registration of the hash valves #1 and #2 for the MAC address MAC#5 to the “destination reference information” is determined as being “unavailable for registration”.

With respect to the MAC address MAC#5, since the hash value C in the “destination reference information” is “unused”, it could be determined as being “allowed for registration”.

However, as in the case of the MAC address MAC#4, since the bitmaps of the hash values #1 and #2 for both of the MAC addresses

MAC#1 and MAC#2 are changed to “11”, it is determined as being “unavailable for registration”.

Next, it is assumed that the hash value #1 =D and the hash value #2=B are obtained for the MAC address MAC#6. Since the hash value #1=D obtained by the hash function #1 is unregistered (in other words, the flag information for the hash value #1 is “0”) but the use flag is “1” indicating “in-use” in the “address registration information”, the hash value #1 =D is not a registration candidate.

Also, since the hash value #2 =B obtained by the hash function #2 is unregistered (in other words, the flag information for the hash value #2 is “0”) but the use flag is “1” indicating “in-use” in the “address registration information”, the hash value #2=B is not a registration candidate.

Therefore, the registration of the hash valves #1 and #2 for the MAC address MAC#6 to the “destination reference information” is determined as being “unavailable for registration”.

Next, it is assumed that the hash value #1=C and the hash value #2=A are obtained for the MAC address MAC#7. Since the hash value #1=C obtained by the hash function #1 is unregistered (in other words, the flag information for the hash value #1 is “0”) and the use flag is also “0” indicating “unused” in the “address registration information”, the hash value #1=C is a registration candidate.

Meanwhile, since the hash value #2=A obtained by the hash function #2 is unregistered (in other words, the flag information for the hash value #2 is “0”) but the use flag is “1” indicating “in-use” in the “address registration information”, the hash value #2=A is not a registration candidate.

Here, even when “1” is registered as the flag information for the hash value #1=C in the “destination reference information”, the bitmaps of the hash values #1 and #2 in the MAC addresses MAC#1 and MAC#2 are maintained in “10”. Therefore, the hash valve #1=C is determined as being “allowed for registration” to the “destination reference information”.

As described above, at the time of address registration, the “address registration information” for the hash value #1 of the hash function #1 is referred to according to the address registration priority. When the hash value #1 of the hash function #1 is unregistered and unused, the hash value #1 is a registration candidate.

Subsequently, it is confirmed whether or not the hash value #2 of the hash function #2 having the next priority is unused with reference to the “address registration information”. When the hash value #2 of the hash function #2 is unused, the registration of the hash values #1 and #2 is determined.

As a result of the reference to the “address registration information”, when the hash value #1 is used, or when the flag information of any one of the hash values #1 and #2 for the registration candidate is “1”, it is determined whether or not the hash value #2 of the hash function #2 having the next priority is allowed to be registered.

As described above, when a collision is occurred in the hash values obtained by the same hash function at the time of address registration, the hash value of the hash function is determined as being “unavailable for registration” for all of the unused hash values and is excluded from the registration candidates.

Further, for the in-use hash values, when a collision is occurred in the hash values obtained by the same hash function at the time of address registration, the hash value of the hash function assigned with a relatively higher address selection priority is determined as being “unavailable for registration” and is excluded from the registration candidates.

With the above determination process, it is possible to correctly select the hash functions #1 and #2 to be used. After the selection, the contents of the hash management table HMT are updated.

At the time of destination reference, the hash value is selected according to the selection rule based on the bit patterns of the hash values #1 and #2. For example, the hash value #2 is selected when it is determined that the flag information is set to “1” with reference to the “destination reference information” for the hash value #2 of the hash function #2 according to the destination selection priority.

When the flag information is set to “0”, the flag information is confirmed for the hash value #1 of the hash function #1 having the next priority, and the hash value #1 whose flag information is “1” is selected.

The entry of the forwarding table FWT is referred and searched based on the selected hash value, and the destination IF number or the like corresponding to the MAC address is identified.

As described above, according to the above-described example, it is possible to reduce the probability of collision in the hash values by using the plurality of hash functions. Even when the collision is occurred in the hash values with low probability, it is possible to suppress an increase in the number of times of reference to the forwarding table FWT, while minimizing an increase in the sizes (in other words, information quantity) of the hash management table HMT and the forwarding table FWT. Therefore, it is possible to prevent the forwarding performance of the transmission apparatus 1 from being deteriorated.

(Entry Deletion Determination)

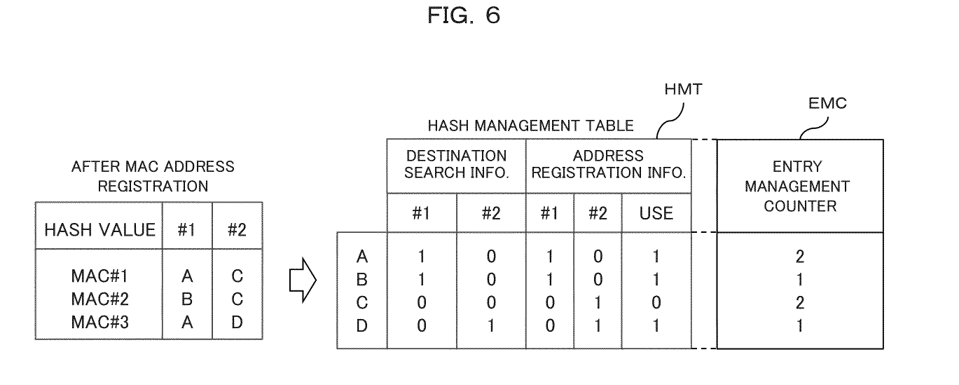

Next, the entry deletion (or update) process of the hash management table HMT in response to the deletion of the registered MAC address will be described with reference to FIG. 6.

As illustrated in FIG. 6, an entry management counter (hereinafter, may simply be referred to as an “entry counter”) EMC may be provided for each hash value of the hash management table HMT. For example, the entry management counter EMC is incremented by 1 (i.e., +1) and decremented by 1 (i.e., −1) according to the registration and deletion of the MAC address.

In the example of FIG. 6, as a result of the registration of three MAC addresses MAC#1 to MAC#3 in the forwarding table FWT, a count value of each entry counter EMC is incremented by 1 (i.e., +1) for the hash values #1 and #2 (A to D) that are the selection candidates. An initial value of the entry counter EMC may be 0.

For example, since the hash value #1=A has been the selection candidate twice for the MAC addresses MAC#1 and MAC#3, the count value of the entry counter EMC corresponding to the hash value A is “2”.

Meanwhile, since the hash value #1=B has been the selection candidate once for the MAC address MAC#2, the count value of the entry counter EMC corresponding to the hash value B is “1”.

Similarly, since the hash value #2=D has been the selection candidate once for the MAC address MAC#3, the count value of the entry counter EMC corresponding to the hash value D is “1”.

Further, since the hash value #2=C has been the selection candidate twice for the MAC addresses MAC#1 and MAC#2, the count value of the entry counter EMC corresponding to the hash value C is “2”.

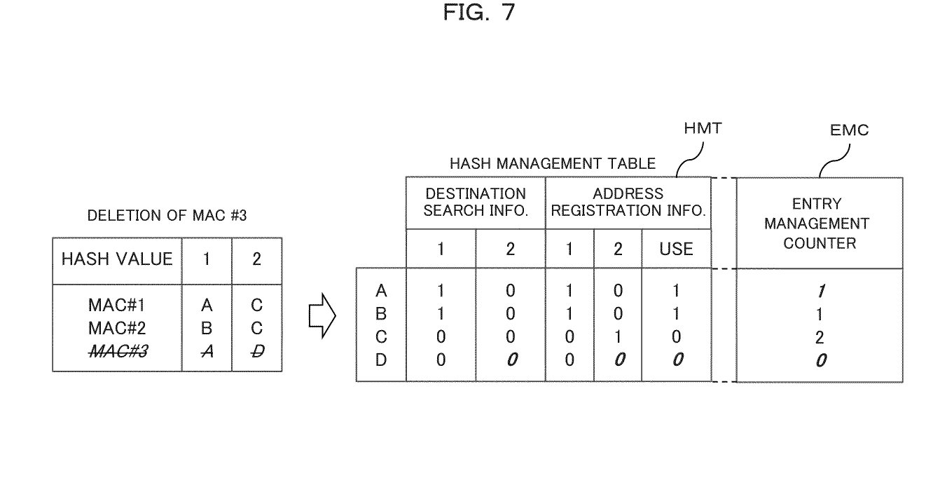

As illustrated on the left side of FIG. 7, it is assumed that the entry of the MAC address MAC#3 has been deleted and therefore the hash value #1=A and the hash value #2=D are deleted.

In this case, as illustrated on the right side of FIG. 7, the count value of the entry counter EMC corresponding to each of the hash values A and D for the MAC address MAC#3 is decremented by 1 (i.e., −1).

As a result of the decrement, since the count value corresponding to the hash value D becomes “0”, the entry corresponding to the hash value D of the hash management table HMT is initialized (for example, updated to all “0”).

In other words, the flag information (including the use flag) in the “destination reference information” and the “address registration information”, which correspond to the hash function having been selected for the deleted MAC address, are disabled.

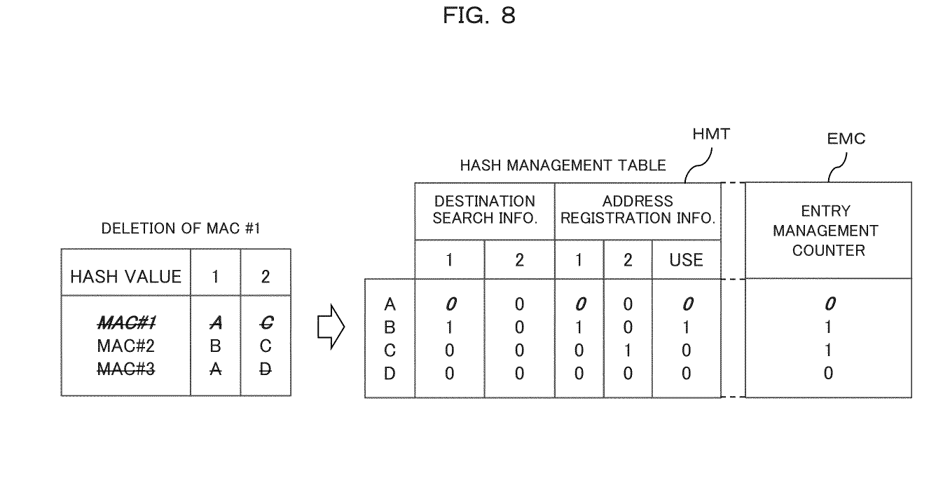

After that, as illustrated on the left side of FIG. 8, it is assumed that the entry of the MAC address MAC#1 has been deleted and therefore the hash value #1=A and the hash value #2=C are deleted. In this case, as illustrated on the right side of FIG. 8, the count value of the entry counter EMC corresponding to each of the hash values A and C for the MAC address MAC#1 is decremented by 1 (i.e., −1).

As a result of the decrement, since the count value corresponding to the hash value A is “0”, the entry corresponding to the hash value A in the hash management table HMT is initialized (for example, updated to all “0”).

In this way, it is available to correctly disable the entry of the hash management table HMT according to the deletion of the registered MAC address.

The entry counter EMC may be prepared for the individual hash functions or may be shared by the hash functions. In a case where the entry counter EMC is prepared for the individual hash functions, it is possible to prevent the flag information from being uselessly enabled. In addition, it is possible to reduce the number of reference times per a table. However, as the number of the hash functions increases, the number of the entry counters EMC also increases.

In addition, the maximum counter value of the entry counter EMC corresponds to the number (may be referred to as the “number of hash degeneration) of possible hash values obtained by degenerating the MAC address space by the hash function, but it can be considered that the probability of all of the possible hash values being deviated is very low.

Therefore, the maximum count value may be set to a smaller value than the number of hash degeneration. Upon exceeding the maximum value, a determination of occurrence of “collision” may be made. Therefore, it is possible to reduce the number of the entry counters EMC to be prepared.

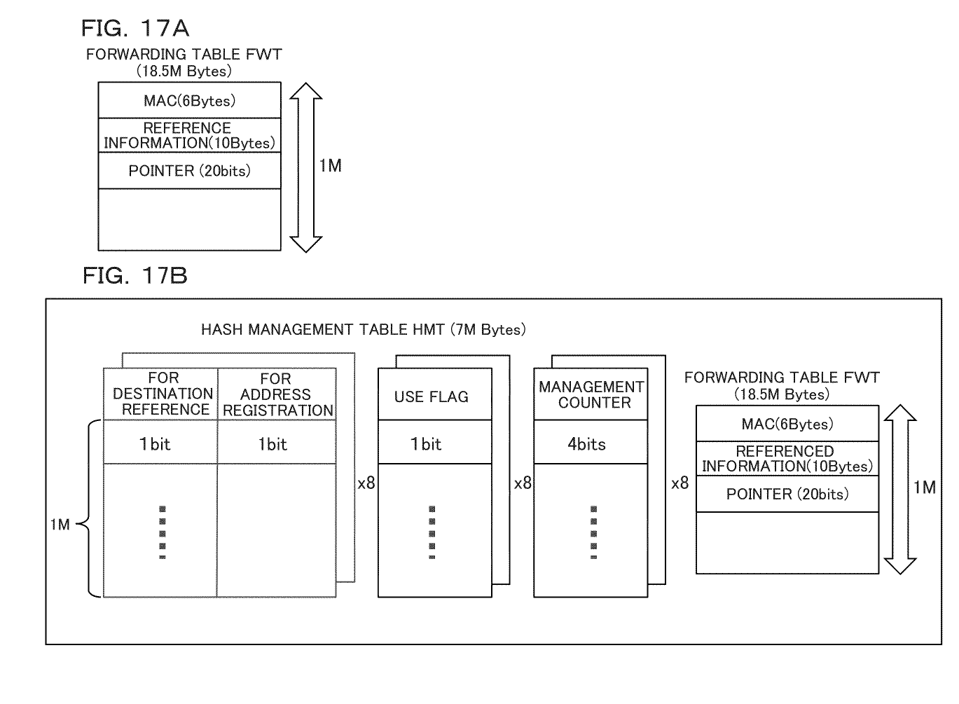

An example of the technical effects of the above-described embodiment will be described with reference to FIGS. 17A and 17B. FIG. 17A illustrates an example in which the number of the entries of the forwarding table FWT is 1 M under the assumption that the MAC address space is degenerated to 1 M entries by the hash function.

For example, one entry of the forwarding table FWT illustrated in FIG. 17A includes the MAC address (e.g., 16 bytes), the reference information (e.g., 10 bytes) like the destination IF number, and the pointer information (e.g., 20 bits).

Therefore, the amount of information per one entry of the forwarding table FWT illustrated in FIG. 17A is 18.5 bytes, and the size of the forwarding table FWT is 1 M entries×18.5 bytes=18.5 M bytes in total.

Meanwhile, FIG. 17B illustrates an example in which the hash management table HMT and the entry counter EMC are provided in the transmission apparatus 1 of the present embodiment in addition to the forwarding table FWT of FIG. 17A.

For example, the hash management table HMT illustrated in FIG. 17B has 1-bit information for each of the “destination reference information”, the “address registration information”, and the “use flag” per one entry. In addition, the entry counter EMC illustrated in FIG. 17B has 4-bit information per one entry, for example.

Therefore, the amount of information of the hash management table HMT and the entry counter EMC per one entry is 7 bits, for example. When it is assumed that the number of the hash functions used in the transmission apparatus 1 is eight, a pair of the hash management table HMT and the entry counter EMC are prepared for eight hash values obtained by the eight hash functions.

Therefore, the amount of the information of the hash management table HMT and the entry counter EMC is 7 bits×8×1 M=56 M bits=7 M bytes under the assumption that the MAC address space is degenerated to 1 M entries by each of the eight hash functions.

Here, in a case of performing a reference (or destination reference) to the forwarding table FWT without using the hash management table HMT and the entry counter EMC illustrated in FIG. 17B, the maximum number of times of destination reference is eight when the hash values of the eight hash functions are not in collision.

In contrast, in the case of using the hash management table HMT and the entry counter EMC illustrated in FIG. 17B, the maximum number of times of destination reference is up to one when the hash values of the eight hash functions are not in collision. In other words, it is possible to reduce the number of times of destination reference to 1/8. In this case, due to the addition of the hash management table HMT and the entry counter EMC, the increase in the table size may be about 30% of 7 M bytes.

Therefore, while suppressing the increase of the table size to the minimum, it is possible to significantly reduce the number of times of destination reference (or access) to the forwarding table FWT.

(Exemplary Process at the Time of Collision in Hash Values)

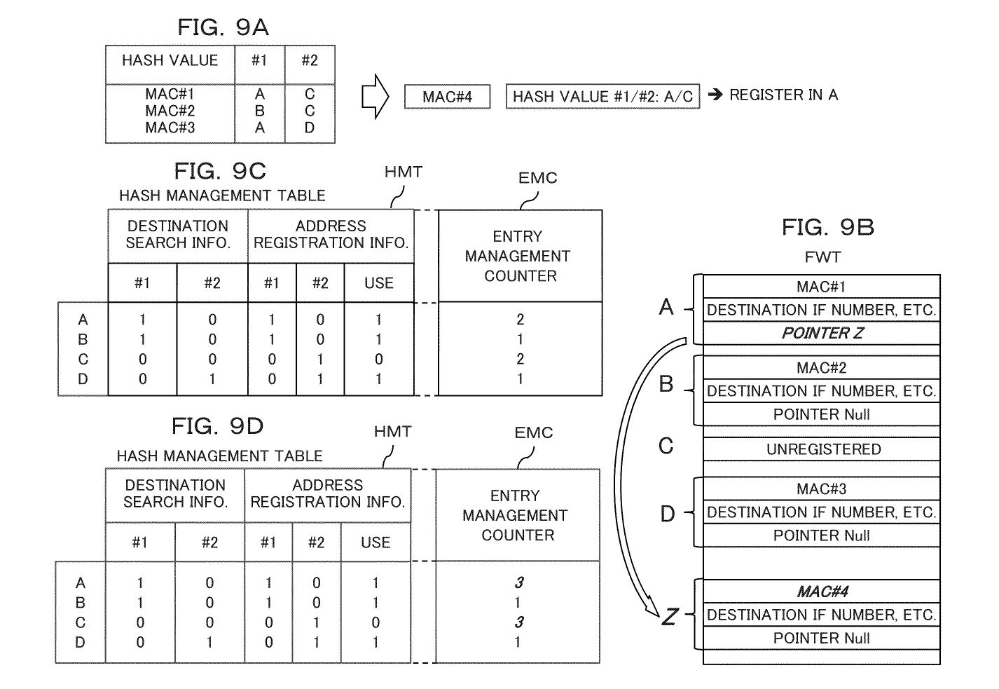

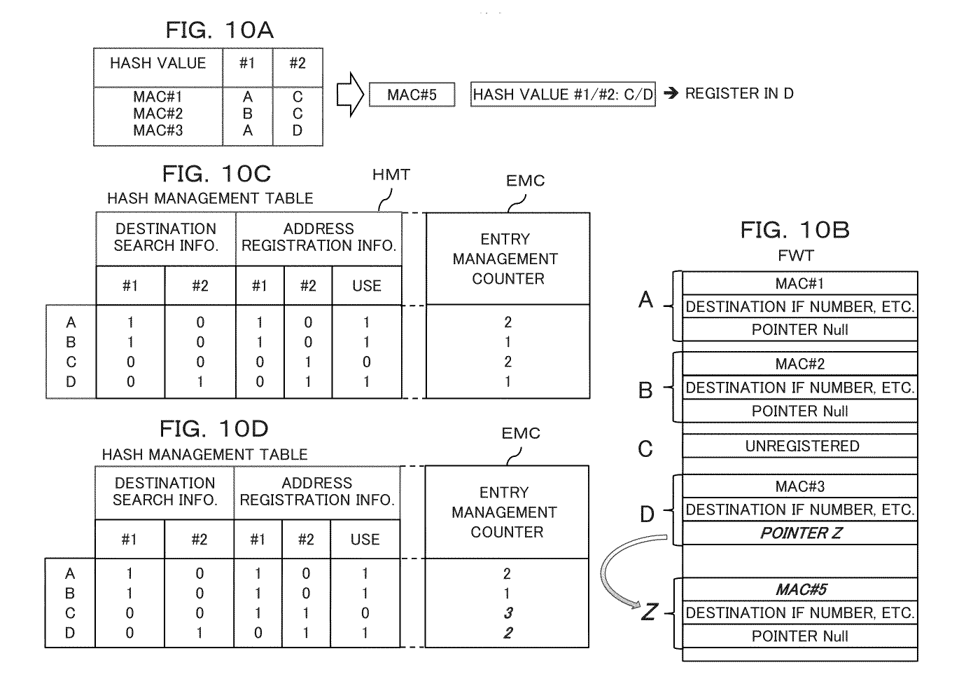

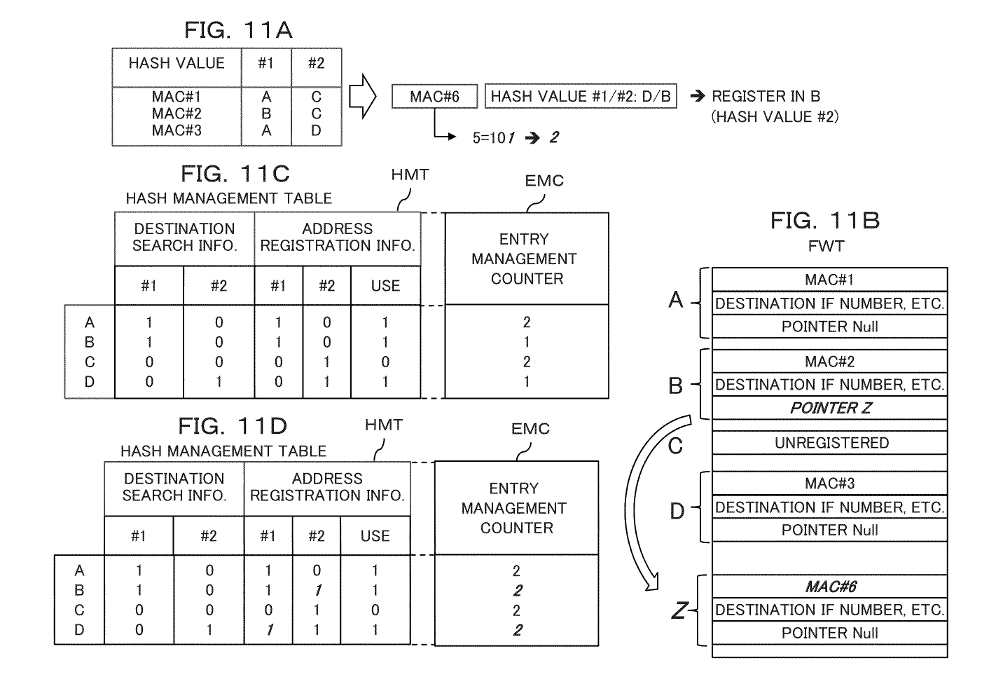

An exemplary process when a collision is occurred in the hash values will be described with reference to FIGS. 9 to 11. FIG. 9 illustrates a first exemplary process at the time of collision in the hash values, FIG. 10 illustrates a second exemplary process at the time of collision in the hash values, and FIG. 11 illustrates a third exemplary process at the time of collision in the hash values.

Although it may be a low probability, when a collision is occurred in the hash values, it is possible to refer to a correct entry in the forwarding table FWT by registering pointer information to the forwarding table FWT as illustrated in FIG. 2.

In this case, since the number of reference times to the forwarding table FWT is increased by tracing the pointer information, the forwarding performance may be deteriorated. However, since the collision probability is suppressed in low as described above, it may be considered that the degree of deterioration is very small.

(First Exemplary Process)

As illustrated in FIGS. 9A and 9C, it is assumed that the hash values #1 and #2 for the MAC addresses MAC#1 to MAC#3 have already been registered. Further, it is assumed that the hash value #1=A and the hash value #2=C which respectively collide with the hash values #1 and #2 of the MAC address MAC#1 are obtained for the MAC address MAC#4.

In this case, as illustrated in FIG. 9B, information on the MAC address MAC#4 and the destination IF number may be registered in the unregistered entry Z of the forwarding table FWT, and the pointer information Z indicating the entry Z is registered in the entry A corresponding to the colliding hash value #1=A.

FIG. 9D illustrates an aspect in which the hash management table HMT and the entry counter EMC illustrated in FIG. 9C are updated according to the registration of the MAC address MAC#4.

After that, when the packet with the MAC address MAC#4 arrives, the entry A of the forwarding table FWT is referred. Since the MAC address MAC#4 is different from the MAC address MAC#1 of the entry A, the entry Z indicated by the pointer information Z is referred. Therefore, the destination IF number of the packet with the MAC address MAC#4 is identified.

(Second Exemplary Process)

As illustrated in FIGS. 10A and 10C, it is assumed that the hash values #1 and #2 for the MAC addresses MAC#1 to MAC#3 have already been registered. Further, it is assumed that the hash value #1=C and the hash value #2=D are obtained for the MAC address MAC#5.

In this case, the hash value #2=D is in collision with the hash value #2=D for the MAC address MAC#3. As illustrated in FIG. 10B, information such as the MAC address MAC#5 and the destination IF number may be registered in the unregistered entry Z of the forwarding table FWT. In addition, the pointer information Z indicating the entry Z may be registered in the entry D corresponding to the colliding hash value D.

FIG. 10D illustrates an aspect in which the hash management table HMT and the entry counter EMC illustrated in FIG. 10C are updated according to the registration of the MAC address MAC#5.

After that, when the packet of the MAC address MAC#5 arrives, the entry D of the forwarding table FWT is referred. Since the MAC address MAC#5 is different from the MAC address MAC#3 of the entry D, the entry Z indicated by the pointer information Z is referred. Therefore, the destination IF number of the packet of the MAC address MAC#5 is identified.

As described above, even when a collision is occurred in the hash values #1 and #2, it is possible to refer to a correct entry in the forwarding table FWT by using the pointer information from the entry corresponding to the colliding hash value.

In the forwarding table FWT, the entry in which the pointer information is to be registered may be set to an entry corresponding to a hash value of a hash function determined to be used in advance.

(Third Exemplary Process)

Alternatively, it may be determined in advance which entry corresponding to a hash value of a hash function is registered the pointer information by using another hash function. An example is illustrated in FIGS. 11A to 11D.

As illustrated in FIGS. 11A and 11C, it is assumed that the hash values #1 and #2 for the MAC addresses MAC#1 to MAC#3 have already been registered. Further, it is assumed that hash value #1=D and the hash value #2=B are obtained for the MAC address MAC#6.

Here, as a non-restrictive example, the hash function may be selected by the least significant bit of the MAC address MAC#6. For example, it is assumed that the hash function #1 is selected when the least significant bit is “0” and the hash function #2 is selected when the least significant bit is “1”.

In this case, when the MAC address MAC#6 is “5” (decimal)=“101” (binary), the least significant bit is “1” and the hash function #2 is selected.

As illustrated in FIG. 11B, the pointer information Z indicating the entry Z of the MAC address MAC#6 is registered in the entry (for example, B) corresponding to the hash value #2 of the selected hash function #2.

FIG. 11D illustrates an aspect in which the hash management table HMT and the entry counter EMC illustrated in FIG. 11C are updated according to the registration of the MAC address MAC#6.

After that, when the packet of the MAC address MAC#6 arrives, the entry B of the forwarding table FWT is referred. Since the MAC address MAC#6 is different from the MAC address MAC#2 of the entry B, the entry Z indicated by the pointer information Z is referred. Therefore, the destination IF number of the packet of the MAC address MAC#6 is identified.

According to the exemplary processes illustrated in FIGS. 9 to 11, even when the collision is occurred in the hash values with low probability, it is possible to correctly refer to the entry corresponding to the MAC address of the forwarding table FWT. Therefore, it is possible to suppress the deterioration of the forwarding performance.

(Multi-Stage Hash function)

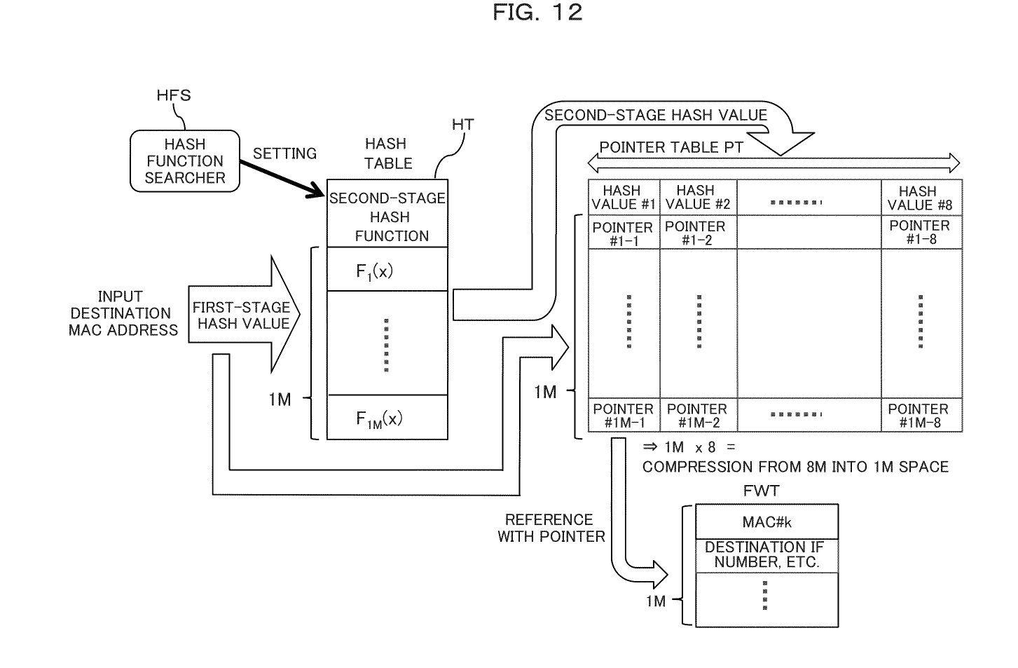

FIG. 12 is a diagram illustrating an example of processing a collision in hash values by using a multi-stage (for example, two-stage) hash function, without increasing a size (in other words, information amount) of a forwarding table FWT.

In FIG. 12, the “first-stage hash value” represents the hash value obtained by the plurality of hash functions (for example, two hash functions) described above. Each of the hash functions may be referred to as “first-stage hash function”.

The “second-stage hash function” may be used to identify the hash value when a collision is occurred in the “first-stage hash values”, for example. As illustrated in FIG. 12, the “second-stage hash function” may be set for each “first-stage hash value”.

In the example of FIG. 12, when the number of the “first-stage hash values” is 1 M (mega), the hash functions F₁(x) to F_{1M}(x) of 1 M entries can be set as an example of the “second-stage hash functions”. The “second-stage hash function” may be set as a “hash table (HT)”. The hash table HT may be data with a table format.

The “second-stage hash function” available to obtain the “second hash values” not being in collision may be registered and set in the hash table HT. The “second-stage hash function” available to obtain the “second-stage values” not being in collision may be identified and selected by searching a preliminarily prepared “second-stage hash function” group by using a hash function searcher HFS.

The “second-stage hash value” may be used for a key to refer and search a pointer table PT in which pointer information to the forwarding table FWT is registered for each of the “second-stage hash values”, for example. In the example of FIG. 12, the “second-stage hash value” can take eight types of hash values #1 to #8.

For example, the pointer information for 1 M entries corresponding to each of 1 M of the “first-stage hash values” can be set to the pointer table PT for each of the hash values #1 to #8.

The entry of the forwarding table FWT corresponding to the MAC address degenerated into the “first-stage hash value” can be referred and identified by referring the pointer table PT with a pair of the “first-stage hash value” and the “second-stage hash value” as a key.

By additionally using the “second-stage hash value”, even when a collision is occurred in the “first-stage hash values”, it is possible to refer and identify a correct entry in the forwarding table FWT.

In this way, by using the multi-stage hash function, it is possible to expand the hash space without increasing the size of the forwarding table FWT. Therefore, it is possible to achieve an appropriate destination reference in the forwarding table FWT.

In the example of FIG. 12, since eight types of the “second-stage hash value” are registered in the pointer table PT, when the number of collisions in the “first-stage hash values” is equal to or less than 8, the forwarding destination information such as the destination IF number or the like can be identified by referring the forwarding table FWT once.

Therefore, it is possible to suppress the deterioration of the forwarding performance, which is caused by the increase in the number of times of accesses to the forwarding table FWT, without increasing the size of the forwarding table FWT. In the example of FIG. 12, the number (1 M) of the entries of the “first-stage hash values” and the number of the entries of the forwarding table FWT are coincided with each other, but may be different from each other.

(Multi-Staged Second-Stage Hash Function)

In the above-described example of FIG. 12, the “second-stage hash function” is searched for a MAC address of which the “first-stage hash value” is in collision, and is available to obtain the “second-stage hash value” not colliding with the other one. Here, as the number of collisions in the “first-stage hash values” is increased, a long time may be taken to search the “second-stage hash function” or the search may be difficult.

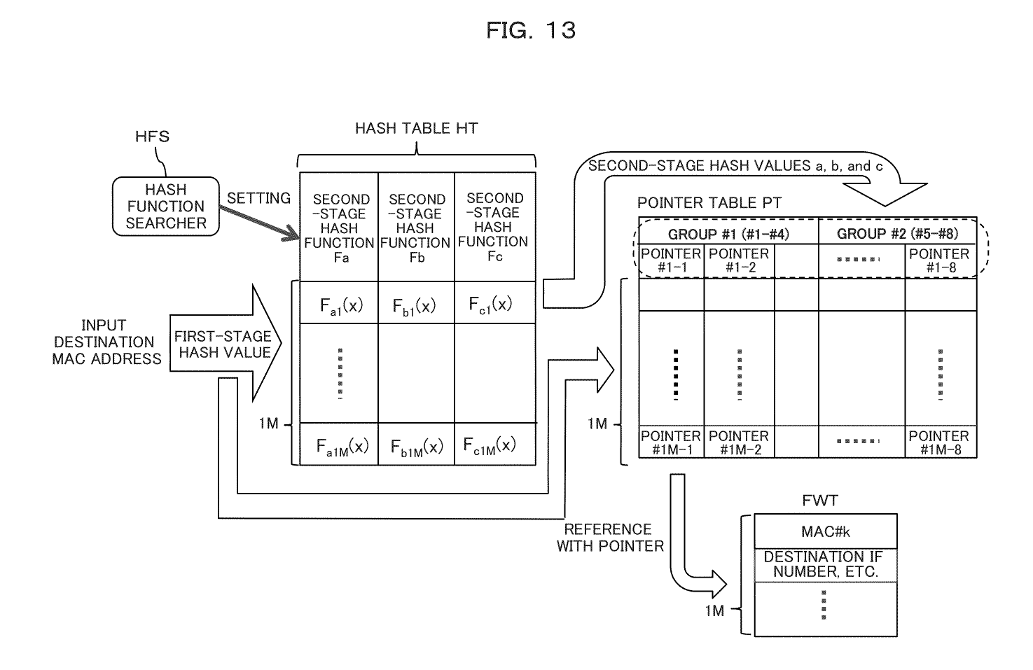

Therefore, as illustrated in FIG. 13, by registering and setting a plurality of “second-stage hash functions” in the hash table HT, it is possible to easily search the “second-stage hash function” available to obtain the “second-stage hash value” not colliding with the other one to thereby facilitate a time taken for the search of the “second-stage hash function”.

For example, it is assumed that the maximum number of collisions of the “first-stage hash value” is 8. Under this assumption, three types of second-stage hash functions Fa, Fb, and Fc may be used, for example. Each of the three types of the “second-stage hash functions Fa, Fb, and Fc” may be set for each of 1 M of “first-stage hash value”.

In the example of FIG. 13, the number of the “first-stage hash values” is 1 M, and the “hash functions Fₐ₁(x) to F_{a1M}(x)” of 1 M entries can be set to the hash table HT as an example of the first “second-stage hash function Fa”.

In addition, as an example of the second “second-stage hash function Fb”, the “hash functions F_{b1}(x) to F_{b1M}(x)” of 1 M entries can be set to the hash table HM. Furthermore, as an example of the third “second-stage hash function Fc”, the “hash functions F_{c1}(x) to F_{c1M}(x)” of 1 M entries can be set to the hash table HM.

The hash function Fa may be used to distribute the colliding maximum eight “first-stage hash values” to a first group #1 of the maximum four hash values #1 to #4 and a second group #2 of the maximum four hash values #5 to #8.

The hash function Fb may be used to distribute the “first-stage hash values”, which are distributed to the first group #1 by the hash function Fa, to any one of the hash values #1 to #4.

The hash function Fc may be used to distribute the “first-stage hash values”, which are distributed to the second group #2 by the hash function Fa, to any one of the hash values #5 to #8.

By the distribution of the “first-stage hash values” using the hash functions Fa to Fc, the hash function searcher HFS just have to search the “second-stage hash function” available to distribute the maximum four hash values.

Therefore, it is possible to reduce the maximum dispersion of the “first-stage hash value”=8 into 4. Therefore, it is possible to easily search (or find) an appropriate “second-stage hash function” available to obtain the “second-stage hash value” not colliding with the other one to thereby facilitate a time taken for the search of the “second-stage hash function”.

In FIG. 13, the pointer table PT may manage the “second-stage hash value” and the pointer information to the forwarding table FWT for each of the first and second groups #1 and #2.

The registration contents or size of the pointer table PT and the reference to the forwarding table FWT by using the pointer information registered in the pointer table PT may be similar to the example of FIG. 12.

(Hash Function Update)

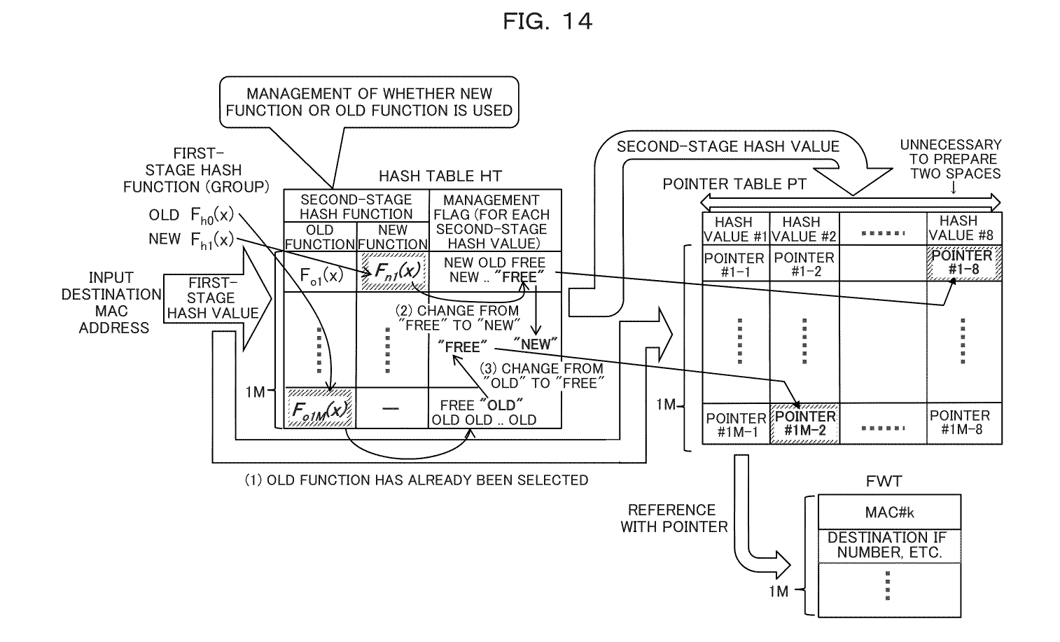

An example of an update process of the hash function when the number of collisions in the “first-stage hash values” is close to the maximum value (for example, 8) will be described with reference to FIG. 14.

When the number of collisions in the “first-stage hash values” is close to the maximum value”, it is preferable to update the “first-stage hash function” to another hash function available to obtain hash values in which the collision is less occurred (in other words, less deviated) than that of the “first-stage hash function”.

In order to enable the “first-stage hash function” to be updated without affecting the communication operation even when the packet transmission apparatus 1 is in communication, two spaces may be prepared for the pointer table PT according to the pre- and post-update of the “first-stage hash function”. However, the hardware scale such as the memory which stores the pointer table PT may be increased.

The pointer table PT illustrated in FIG. 14 has a space of 8M entries, and ⅞ or more of a region is unused (or free). Therefore, the hash function may be updated by using the free space.

In FIG. 14, the “second-stage hash function” and the management flag can be registered and set in the hash table HT according to the “first-stage hash value” obtained by the pre- and post-updated “first-stage hash function”. In the example of FIG. 14, the pre-updated (in other words, old) “first-stage hash function” is represented by “Fₕ₀(x)”, and the post-updated (in other words, new) “first-stage hash function” is represented by “Fₕ₁(x)”.

As the “second-stage hash function”, the two types of old and new hash functions can be set for each of the two types of old and new “first-stage hash values” (for example, 1M×2) obtained by the pre- and post-updated “first-stage hash functions”.

In the example of FIG. 14, as an example of the “second-stage old hash function” (hereinafter, may simply be referred to as “old function”) corresponding to the pre-updated “first-stage hash value”, the old functions F_{c1}(x) to Fₒ₁(x) of maximum 1 M entries can be set in the hash table HT. The same applies to the “second-stage new hash function” (hereinafter, may simply be referred to as “new function”) corresponding to the post-updated “first-stage hash value”.

The “management flag” may be flag information such as “new” representing the post-update of the function, “old” representing the pre-update of the function, and “free” representing an unused state. For example, the “management flag” can be set for each of the “second-stage hash values”. By referring the “management flag”, it is possible to identify which one of the new and old hash functions is selected.

Hereinafter, an example of registration to the hash table HT and the pointer table PT at the time when the function is updated will be described.

First, the hash function searcher HFS searches one or more new “first-stage hash functions Fₕ₁(x)” available to distribute the “first-stage hash values” in a smaller number of collisions for the currently registered MAC address.

The hash function searcher HFS checks whether or not a free space is present in the pointer table PT corresponding to the hash value obtained by the new “first-stage hash function Fₕ₁(x)”.

When the empty space is present, the hash function searcher HFS searches the “second-stage hash function” available to be assigned to the free space, and registers and sets the “second-stage hash function” obtained by the search to the hash table HT. In the example of FIG. 14, the “second-stage function Fₕ₁(x)” is set to the hash table HT.

The hash function searcher HFS updates the “management flag”, which corresponds to the new hash value of the set new “second-stage hash function Fₙ₁Ax)”, to “new” in the hash table HT. In addition, the hash function searcher HFS updates the “management flag” corresponding to the old hash value to “free”.

Further, the hash function searcher HFS registers and sets the pointer information corresponding to the new hash value in the pointer table PT. The pointer information corresponding to the old hash value may be deleted from the pointer table PT.

The above process is repeated for each of the new hash values of the new “first-stage hash function”. Therefore, the new pointers are registered to possibly fit in the free space of the pointer table PT for the new hash values of the new “first-stage hash function”.

When the free space is insufficient for the above assignment in the hash table HT and the pointer table PT, the assignment to the new hash value may be performed partially. In this case, all of the first-stage and second-stage hash functions may be restored to the old functions. After the restoration to the old function, the “first-stage hash function” may be re-selected.

According to the above-described example of FIG. 14, it is possible to adaptively update a hash function to another hash function available to obtain hash values in the smaller number of collisions than that of the pre-updated hash function, without preparing multi pointer tables PT and affecting the communication operation of the transmission apparatus 1. Therefore, it is possible to suppress the deterioration of the forwarding performance during the communication of the transmission apparatus 1.

(Additional CAM)

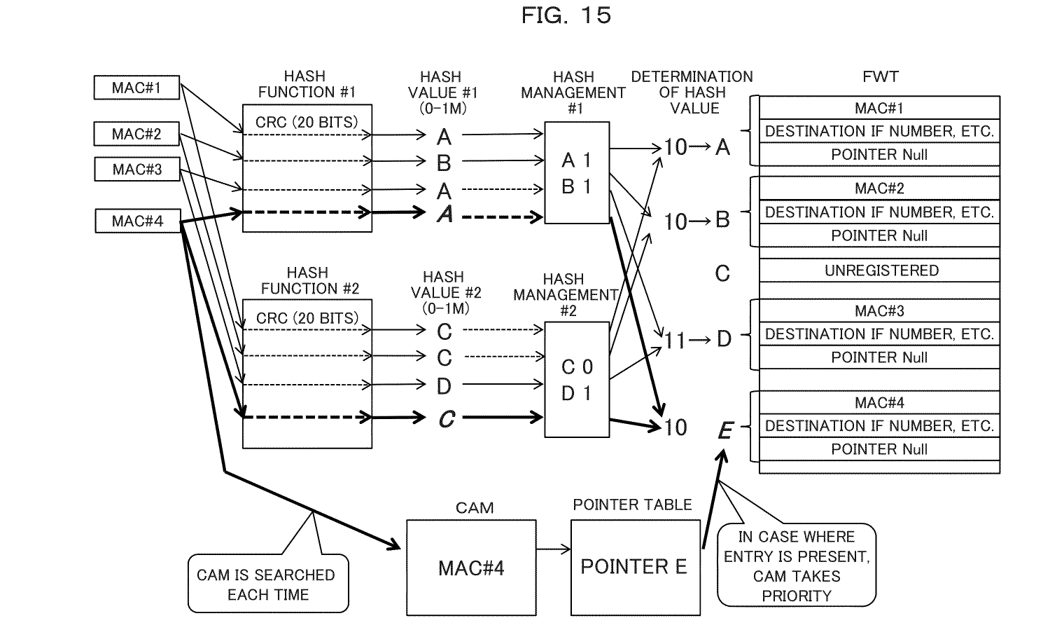

As a modification of FIG. 4, a method of performing address registration and destination reference by additionally using a content addressable memory (CAM) for the collision in the hash values will be described with reference to FIG. 15.

In the example of FIG. 15, after the MAC addresses MAC#1 to MAC#3 are registered as described with reference to FIG. 4, the hash value #1=A is obtained by the hash function #1 and the hash value #2=C is obtained by the hash function #2, for the MAC address MAC#4.

However, the hash value #1=A and the hash value #2=C collide with the hash value #1=A and the hash value #2=C for the registered MAC address MAC#1.

The MAC address MAC#4 for which a collision is occurred in the hash value is registered in the entry (for example, entry E in FIG. 15) of the forwarding table FWT and is also registered in the CAM.

The CAM returns an address value corresponding to an input MAC address. The address value is associated with pointer information which is registered in a CAM pointer table CPT and indicative of the entry of the forwarding table FWT. The pointer information indicates the entry E in the forwarding table FWT of the MAC address MAC#4 for which the collision is occurred in the hash values.

At the time of the destination reference, the CAM is searched parallel to (or may be sequential to) the determination of the hash value. In the example of FIG. 15, the result of the hash value determination for the MAC address MAC#4 is a hash value A, but the MAC address MAC#4 has already been registered in the CAM.

Therefore, the pointer E in the CAM pointer table CPT is selected, and the entry E of the forwarding table FWT in which the MAC address MAC#4 is registered is referred.

In this way, the MAC address for which a collision is occurred in the hash values is separately registered in the CAM. Therefore, even when the collision is occurred in the hash values, it is possible to suppress the increase in the number of times of references to the forwarding table FWT, thereby suppressing the deterioration of the forwarding performance.

The capacity of the CAM has just to be a sufficient capacity to process a possible hash value collision with a low occurrence probability. Therefore, the capacity of the CAM may be limited to a capacity corresponding to the probability of collision in the hash values.

(Simplification of Hash Function)

In the case of using the plurality of hash functions as described above, when each of the hash functions performs a complicated calculation, the calculation load may be increased.

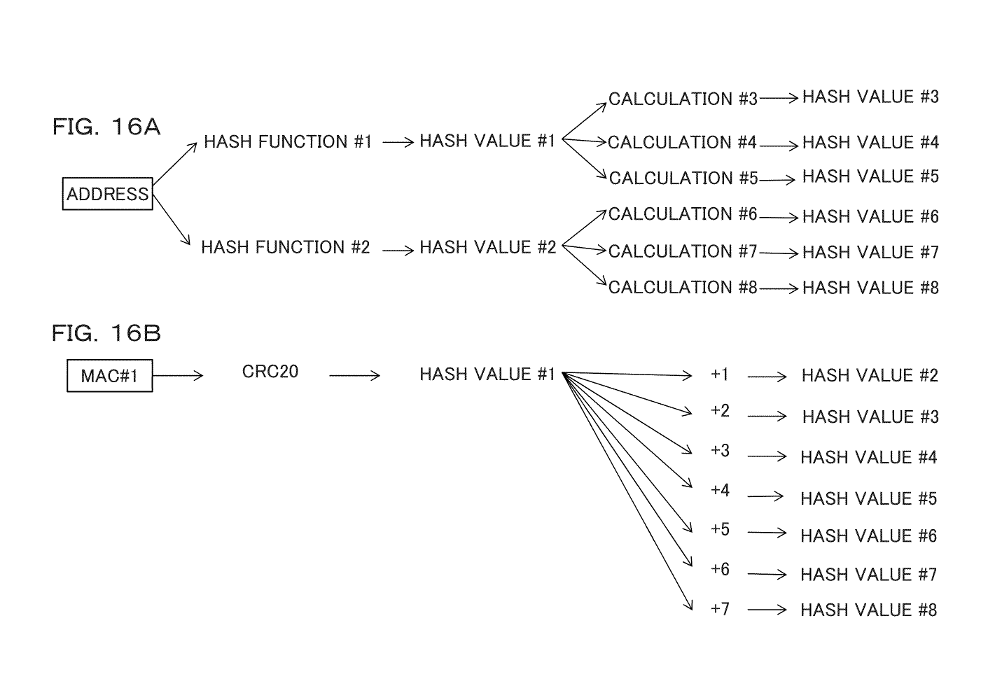

For example, as schematically illustrated in FIG. 16(A), the hash values #1 and #2 are obtained by the calculation of two hash functions #1 and #2.

Furthermore, the hash values #3 to #5 and #6 to #8 are obtained from the hash values #1 and #2 by the hash functions #3 to #5 and #6 to #8.

In this case, when the calculation of each of the hash functions #1 to #8 is complicated, the calculation load may be increased and the amount of the hard resources used for the hash calculation may be increased.

Therefore, one (or a part of) hash value is calculated by the hash function, and the other hash values may be calculated by applying a simpler calculation to the calculated hash value by the hash function.

For example, as schematically illustrated in FIG. 16B, one hash value #1 is obtained by the hash function of the CRC20, and the other hash values #2 to #8 are obtained by the simple calculation (for example, addition of a predetermined value corresponding to the hash value number).

In the example of FIG. 16B, values obtained by adding [+1], [+2], . . . , and [+7] to the hash values #1 may be used as the hash values #2 to #8.

Therefore, a plurality of different hash values can be obtained by a simple calculation and it is possible to suppress the increase in the amount of the hardware resources used for the hash calculation.

A simple calculation method (may also be referred to as a “calculation rule”) may be common or different for all or part of different hash values (for example, the hash values #2 to #8 of FIG. 16B).

(First Exemplary Configuration of Transmission Apparatus 1)

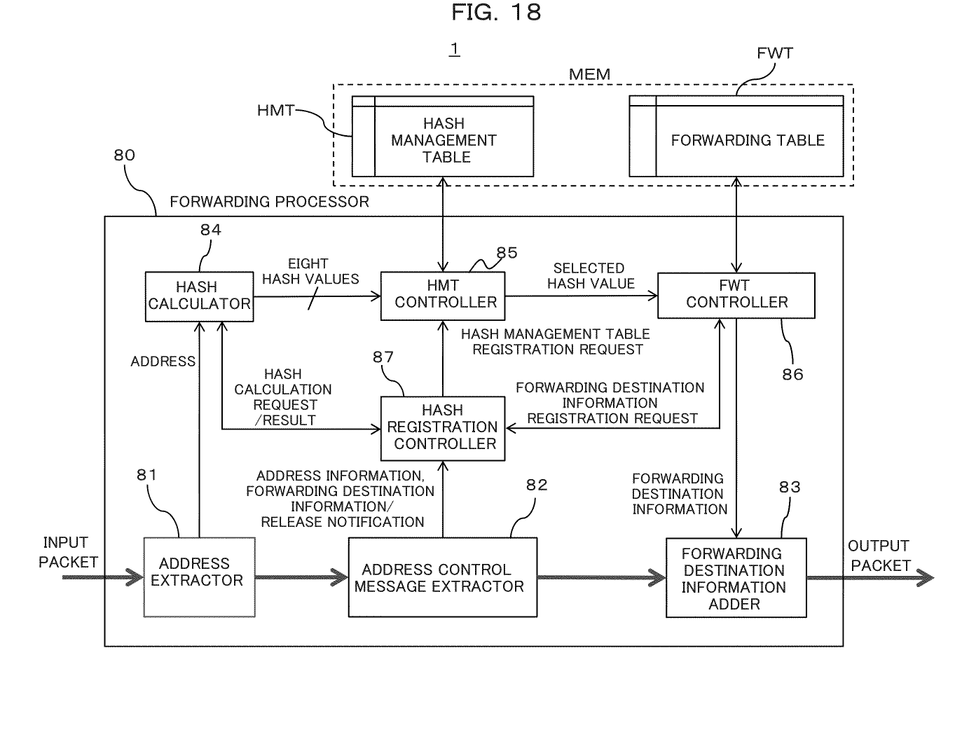

FIG. 18 illustrates a first exemplary configuration of the transmission apparatus 1 operable to perform the various above-described processes. The first exemplary configuration may be considered as corresponding to a functional configuration example operable to perform the processes illustrated in FIGS. 4 to 11.

For example, the transmission apparatus 1 illustrated in FIG. 18 may include an address extractor 81, an address control message extractor 82, and a forwarding destination information adder 83. Further, the transmission apparatus 1 may include a hash calculator 84, a hash management table (HMT) controller 85, a forwarding table (FWT) controller 86, and a hash registration controller 87. Furthermore, the transmission apparatus 1 may include the hash management table HMT and the forwarding table FWT described above.

An entry counter EMC may be included in the hash management table HMT. The hash management table HMT may be provided for each of the plurality of hash functions. Each of the above blocks 81 to 87 may be considered as being an element of the forwarding processor 80. The “forwarding processor 80” may be referred to as a “forwarding controller 80”.

The hash management table HMT (which may include the entry counter EMC) and the forwarding table FWT may be stored in a memory MEM. The memory MEM is an example of a storage device or a storage medium.

The hash management table HMT (which may include the entry counter EMC) and the forwarding table FWT may be stored in different storage regions of the single memory MEM, or may be stored in distributed storage regions of a plurality of different memories MEM.

The address extractor 81 extracts address information (for example, MAC address), which is used to refer to the forwarding table FWT, from the received packet. The extracted address information is provided to the hash calculator 84. The received packet from which the address is extracted is input to the address control message extractor 82.

When the received packet from the address extractor 81 is an address control message, the address control message extractor 82 performs a process corresponding to the contents of the address control message (may also be referred to as “address control information).

An example of the address control message is an in-band address registration request message or an in-band address release request message. The address control message may be provided as an out-band control message given from the controller 13 to the address control message extractor 82 of the transmission apparatus 1. In addition, the address control message may be autonomously generated by the address control message extractor 82, based on the in-band information of the egress side.

When the address registration request message is received, the address control message extractor 82 extracts the address information to be registered to the forwarding table FWT and the forwarding destination information (for example, destination IF number or the like) corresponding to the address information, from the received message.

Meanwhile, when the address release request message is received, the address control message extractor 82 extracts the address information to be released and the forwarding destination information corresponding to the address information to be released.

Upon receiving any of messages, the extracted information may be provided to the hash registration controller 87.

The forwarding destination information adder 83 adds the forwarding destination information given from the FWT controller 86 to the received packet to be forwarded. The packet given the forwarding destination information is output to the SWF 12 (see FIG. 1).

The hash calculator 84 calculates a plurality of hash values (for example, eight hash values) by applying hash calculations based on a plurality of hash functions (for example, eight hash functions) to the address information extracted by the address extractor 81. The obtained hash values are provided to the HMT controller 85. It may be considered that the hash calculator 84 corresponds to the above-described hash function searcher HFS or has a function as the hash function searcher HFS.

The HMT controller 85 selects any one of the plurality of hash values with reference to the hash management table HMT. The selected hash value is provided to the FWT controller 86.

The FWT controller 86 refers the forwarding table FWT with the hash value provided from the HMT controller 85 to identify the forwarding destination information such as the destination IF number or the like. The identified forwarding destination information is provided to the forwarding destination information adder 83.

The hash registration controller 87 controls, for example, the hash calculator 84, the HMT controller 85, and the FWT controller 86, based on the information extracted from the address control message by the address control message extractor 82

For example, the hash registration controller 87 requests the hash calculator 84 to calculate the hash value of the address information in response to the reception of the forwarding destination information and the address information extracted from the address registration request message.

The hash calculator 84 calculates the plurality of hash values corresponding to the address information in response to the request from the hash registration controller 87 and provides the calculated hash values to the HMT controller 85. In this regard, the hash calculator 84 may respond a completion of the hash calculation to the hash registration controller 87.

In response to a reception of the response from the hash calculator 84, the hash registration controller 87 provides the hash management table registration request to the HMT controller 85 to update the hash management table HMT by the HMT controller 85. In this regard, the hash registration controller 87 controls the FWT controller 86 to also update the forwarding table FWT according to the update of the hash management table HMT. The requests for the hash calculator 84 and the HMT controller 85 may be performed in parallel.

The HMT controller 85 and the hash registration controller 87 may be considered as constituting an example of a “hash controller”. The “hash controller” controls a selection of a hash value to be used for the reference based on the hash management table HMT which indicates whether or not each of the hash values is in-use to refer the forwarding table FWT for each hash function.

The FWT controller 86 registers the address information requested to be registered and the forwarding destination information corresponding to the registration-requested address information to the forwarding table FWT to update the forwarding table FWT according to the control of the hash registration controller 87. The FWT controller 86 is an example of the forwarding controller.

The hash registration controller 87 controls the controllers 85 and 86 to update (for example, initializes) the entry requested to be released in the tables HMT and FWT in response to the reception of the forwarding destination information and the address information extracted from the address release request message.

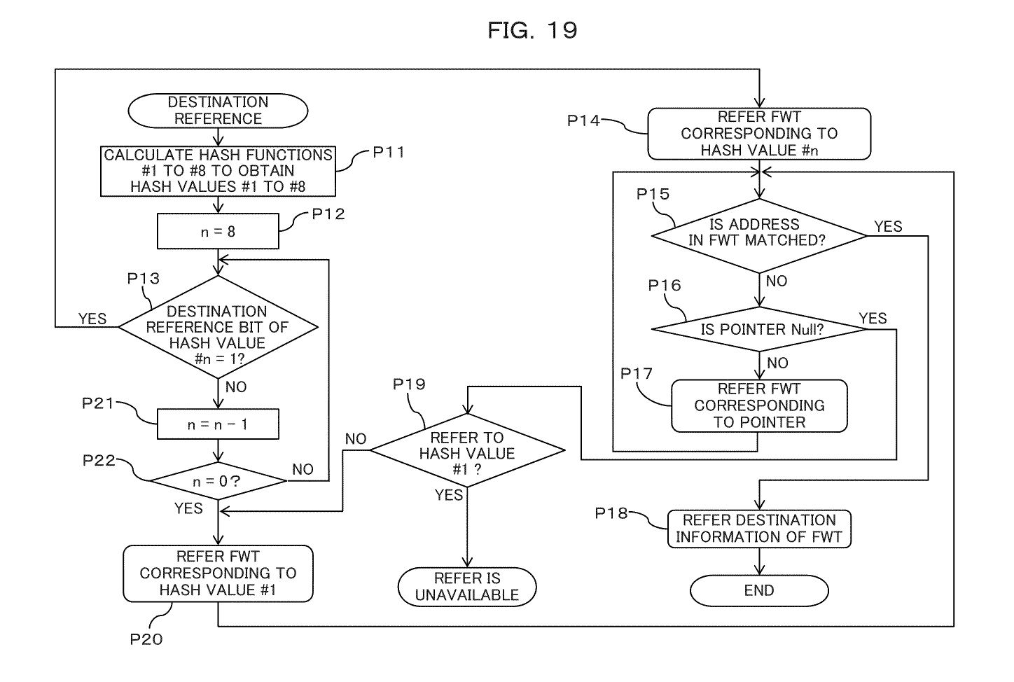

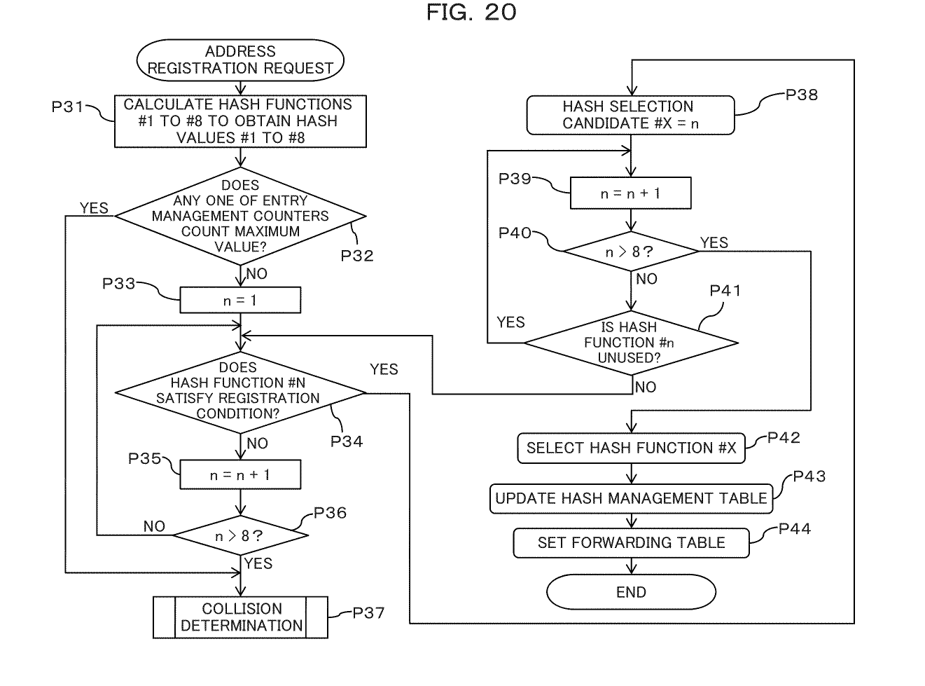

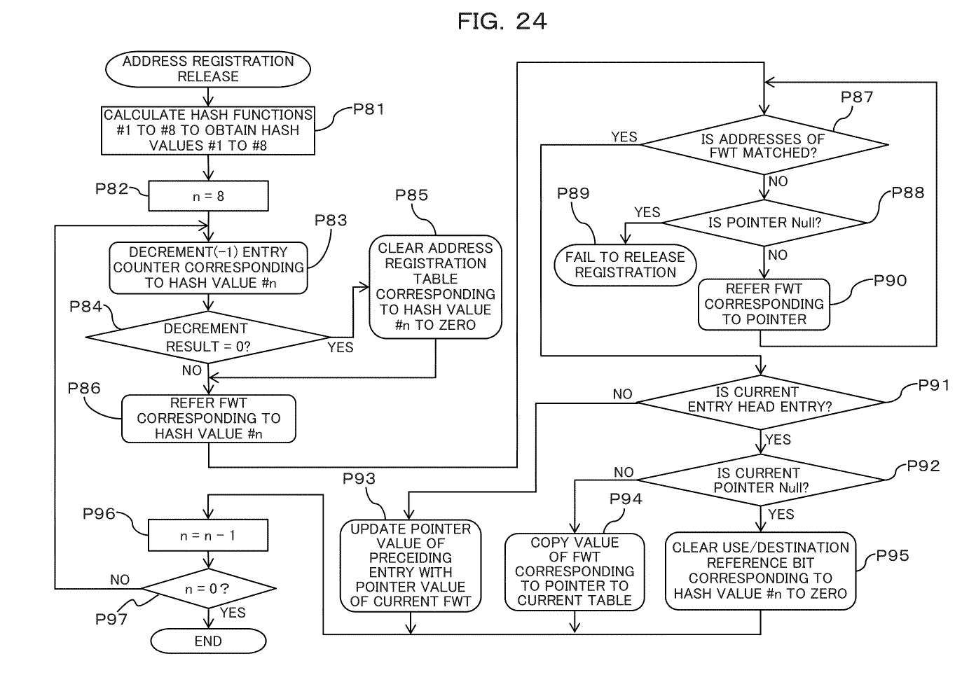

FIGS. 19 to 24 illustrate an exemplary operation of the transmission apparatus 1 (for example, the forwarding processor 80) having the configuration illustrated in FIG. 18. FIG. 19 is a flowchart illustrating an exemplary operation of the forwarding processor 80 at the time of destination reference. FIGS. 20 to 23 are flowcharts illustrating exemplary operations of the forwarding processor 80 at the time of address registration. FIG. 24 is a flowchart illustrating an exemplary operation of the forwarding processor 80 at the time of releasing an address registration.

(Exemplary Operation at Time of Destination Reference)

At the time of destination reference, the forwarding processor 80 operates according to the flowchart illustrated in FIG. 19. With the operation, the destination reference process described above with reference to FIGS. 4 and 5 is achieved.

For example, the hash calculator 84 of the forwarding processor 80 calculates the hash values #1 to #8 by using eight hash functions #1 to #8 for the address information extracted by the address extractor 81 (process P11).

The HMT controller 85 checks the “destination reference information” of the hash management table HMT corresponding to the hash functions #1 to #8 (in other words, the hash values #1 to #8).

For example, the HMT controller 85 sets the count value of the decrement counter to check the “destination reference information” to “n =8” corresponding to the number of the hash values #1 to #8 to be checked (process P12).

The HMT controller 85 checks whether or not the flag information (for example, bit) of the “destination reference information” for the hash value #8 is “1” (process P13). When there is the “destination reference information” whose flag information is “1” (YES in process P13), the HMT controller 85 selects the hash value #n and notifies the selected hash value #n to the FWT controller 86. The FWT controller 86 refers the entry of the forwarding table FWT corresponding to the notified selected hash value #n (process P14).

The FWT controller 86 determines whether or not the address information registered in the referred entry and the address information extracted by the address extractor 81 are matched with each other (process P15). The address information registered in the forwarding table FWT may be referred to as “registered address”, and the address information extracted by the address extractor 81 may be referred to as “extracted address”.

When the registered address and the extracted address are not matched with each other (NO in process P15), the FWT controller 86 further checks whether or not the pointer information of the referred entry is “Null” (process P16).

When the pointer information of the referred entry is not “Null” (NO in process P16), the FWT controller 86 refers the entry of the forwarding table FWT corresponding to the pointer information (process P17) and determines whether or not the address information is matched (process P15).

In this way, the FWT controller 86 traces the pointer information and searches the entry of the forwarding table FWT, in which the registered address matched with the extracted address is registered (NO in process P15 and process P16).

When the entry of the forwarding table FWT, in which the registered address matched with the extracted address is registered, is found (YES in process P15), the FWT controller 86 refers the forwarding destination information of the referred entry (process P18).

The forwarding destination information is provided to the forwarding destination information adder 83, and the forwarding destination information is added to the packet output from the forwarding destination information adder 83 to the SWF 12.

In process P16, when the pointer information is “Null” (YES in process P16), the FWT controller 86 checks whether or not the referred entry is an entry corresponding to the hash value #1 (process P19).

When the referred entry is the entry corresponding to the hash value #1 (YES in process P19), the FWT controller 86 determines that the corresponding entry is not found (in other words, is unavailable for reference) in the forwarding table FWT. The determination result indicative of the unavailable reference may be notified to the controller 13 of the transmission apparatus 1 or an external device as error information or alarm information, or the like.

When the referred entry is not the entry corresponding to the hash value #1 (NO in process P19), the FWT controller 86 refers the entry of the forwarding table FWT corresponding to the hash value #1 (process P20) and performs the processes P15 to P19.

In addition, in the process P13, when the flag information of the “destination reference information” corresponding to the hash value #n is “0” (NO in process P13), the HMT controller 85 decrements the count value of the decrement counter (n=n−1) (process P21).

The HMT controller 85 checks whether or not the flag information of the “destination reference information” for the remaining hash values #7 to #1 is “1”, in descending order (NO in processes P22 and P13), until the count value becomes n=0 (until determined as YES in process P22).

The reason for “descending order” is because the “destination reference priorities” of the hash functions #1 to #8 are set, for example, in descending order. Therefore, when the “destination reference priorities” of the hash functions #1 to #8 are set in ascending order, the check of the flag information may be performed in ascending order.

When there is the hash value #n whose flag information is “1” (YES in process P13), the HMT controller 85 performs the above-described processes P14 to P20.

When the count value of the decrement counter becomes n=0 (YES in process P22), it is confirmed that the flag information of the “destination reference information” is “0” for all of the hash values #1 to #8.

In response to the confirmation, the HMT controller 85 selects the hash value #1 and notifies the selected hash value #1 to the FWT controller 86. The FWT controller 86 refers the entry of the forwarding table FWT corresponding to the notified selected hash value #1 (process P20) and performs the processes subsequent to the process P15.

(Exemplary Operation at Time of Address Registration)

An exemplary operation of the forwarding processor 80 at the time of address registration will be described with reference to FIGS. 20 to 23. The forwarding processor 80 operates according to the flowcharts illustrated in FIGS. 20 to 23 to achieve the address registration process described above with reference to FIGS. 4 and 5 for example.

For example, an address registration request message of the address information is received at the address control message extractor 82 (see FIG. 18), and the address information of the registration request and the forwarding destination information are provided to the hash registration controller 87.

In this case, as illustrated in FIG. 20, the hash registration controller 87 requests the hash calculator 84 to calculate the hash value for the address information requested to be registered (hereinafter, also referred to as “registration requested address information”).

In response to the request, the hash calculator 84 calculates a plurality of hash values #1 to #8 (for example, eight hash values) for the registration requested address information by using a plurality of hash functions #1 to #8 (for example, eight hash functions) (process P31). The calculated hash values #1 to #8 are transmitted to the HMT controller 85.

In addition, the hash registration controller 87 transmits a hash management table registration request to the HMT controller 85. In response to the request, the HMT controller 85 checks whether or not any one of entry counters EMC counts a maximum value (process P32).

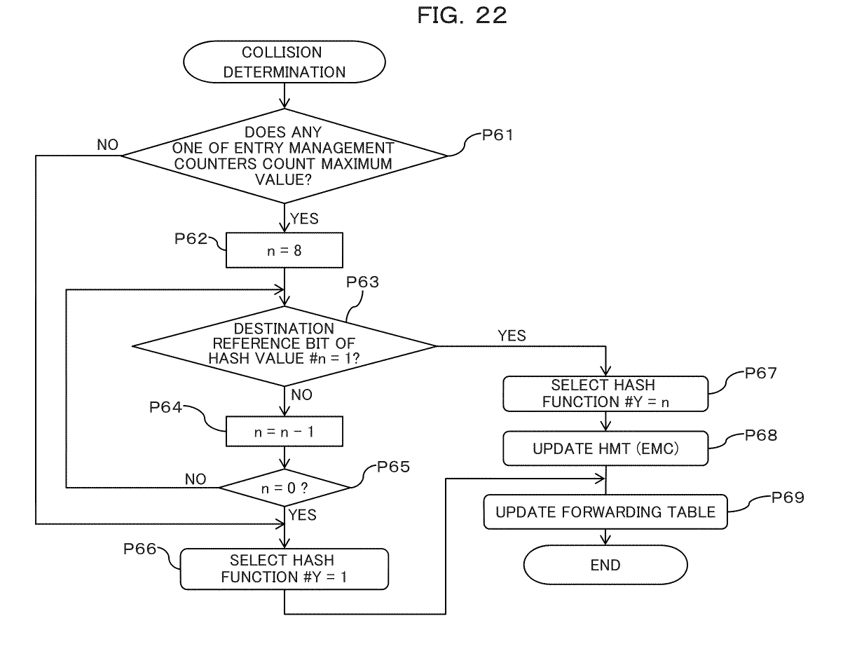

When any one of the entry counters EMC counts the maximum value (YES in process P32), the HMT controller 85 performs a collision determination process (P37) as illustrated in FIGS. 9 to 11. An example of the collision determination process will be described below with reference to FIG. 22.

Meanwhile, when any one of the entry counters EMC does not count the maximum value (NO in process P32), the HMT controller 85 checks whether or not any one of the hash functions #1 to #8 is available to be registered (in other words, satisfies the registration condition) (processes P33 to P36).

For example, the HMT controller 85 sets the count value n of the increment counter to “n=1” (process P33) and checks whether or not the hash function #n satisfies a registration condition (process P34).

When the hash function #n does not satisfy the registration condition (NO in process P34), the HMT controller 85 increments the count value n of the increment counter (n=n+1) (process P35) and checks whether or not the hash function #n satisfies n>8 (the number of the hash functions) (process P36).

When the hash function #n not satisfy n>8 (NO in process P36), in other words, when there is a hash function for which the registration condition has not yet been checked, the HMT controller 85 returns to the process P34.

When the hash function #n satisfies n>8 (YES in process P36), the HMT controller 85 performs the collision determination process to be described with reference to FIG. 22 (process P37).

When the hash function #n satisfying the registration condition is found during the check of the registration condition (YES in process P34), the HMT controller 85 sets the hash function #n as a hash selection candidate X (process P38).

Then, the HMT controller 85 increments the count value n of the increment counter (n=n+1) (process P39) and checks whether or not n>8 is satisfied (process P40).

When the count value n does not satisfies n>8 (NO in process P40), the HMT controller 85 checks whether or not the hash function #n is unused (process P41). When the hash function #n is unused, the HMT controller 85 increments the count value n by 1 until the count value n satisfies n>8 to check the presence or absence of the unused hash function #n. In other words, the presence or absence of the unused hash function #n is checked in ascending order.

The reason for “ascending order” is because the “address registration priorities” of the hash values #1 to #8 are set in ascending order, for example. Therefore, when the “address registration priorities” of the hash functions #1 to #8 are set in descending order, the check of the unused hash function #n may be performed in descending order.

When the hash function #n has been used (NO in process P41), the HMT controller 85 returns to the processes subsequent to the process P34 and checks whether or not the hash function #n satisfies the registration condition.

Under the process (process P40) of checking the use or non-use of the hash function #n, when the count value n satisfies n>8, the HMT controller 85 selects the hash function #n of the hash selection candidate X (process P42).

The HMT controller 85 updates the hash management table HMT with the selected hash function #n (process P43). In addition, the HMT controller 85 notifies the selected hash value #n to the FWT controller 86. The FWT controller 86 sets the entry of the forwarding table FWT according to the notified hash value #n (process P44).

As described above, the registration of the hash management table HMT and the forwarding table FWT corresponding to the address information requested to be registered is completed.

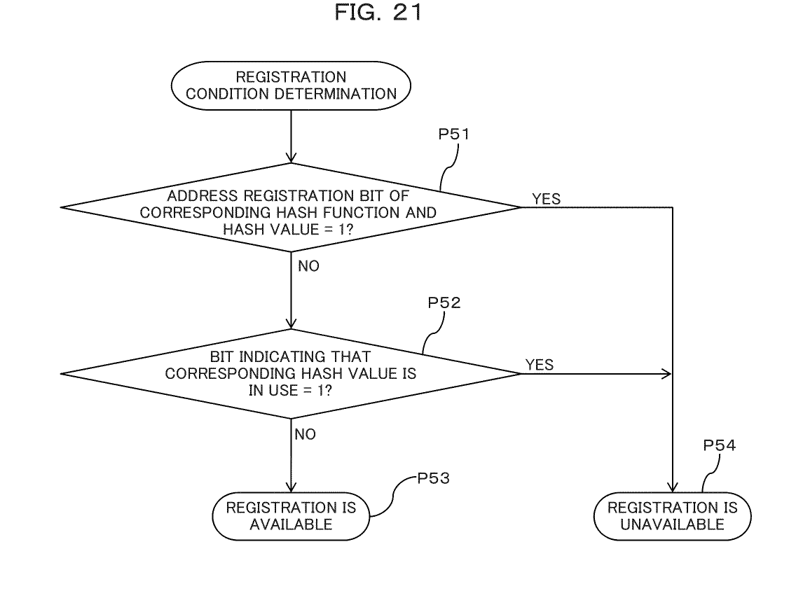

Next, an illustrative example of the above-described registration condition determination process (P34) of the hash function #n will be described with reference to FIG. 21.

As illustrated in FIG. 21, the HMT controller 85 refers the hash management table HMT to check whether or not the “address registration information (e.g., bit)” of the hash function #n and the hash value #n is “1” (registered) (process P51).

When the “address registration information (bit)” is “0” (unregistered) (NO in process P51), the HMT controller 85 further checks whether or not the “use flag” corresponding to the hash value #n is “1” (in-use) (process P52).

When the “use flag” is “0” (not used) (NO in process P52), the HMT controller 85 determines that the hash function #n (or hash value #n) is available to be registered in the hash management table HMT (process P53). In other words, it is determined that the registration condition is satisfied (YES) in the process P34 of FIG. 20.

Meanwhile, when the “address registration information (bit)” is “1” (YES in process P51), the HMT controller 85 determines that the hash value #n is unavailable to be registered (process P54).

In addition, when the “address registration information (bit)” is “0” but the “use flag” is “1” (NO in process P51 and YES in process P52), the HMT controller 85 determines that the hash value #n is unavailable to be registered (process P54).

In other words, the hash value #n determined as YES in the processes P51 and P52 is determined as being “unavailable to be registered” and is determined as NO in the process P34 of FIG. 20. The above-described check processes P51 and P52 may be performed in reverse order or in parallel.

(Collision Determination Process)

Next, an example of the collision determination process (P37) illustrated in FIG. 20, which is performed by the HMT controller 85, will be described with reference to FIG. 22. The HMT controller 85 operates according to the flowcharts illustrated in FIG. 22 to achieve the “process at the time of collision in hash values” described above with reference to FIGS. 9 to 11.

As illustrated in FIG. 22, the HMT controller 85 refers the entry counters EMC to check whether or not the count value in any one of entries reaches a maximum value (process P61).

When the count value reaches the maximum value (YES in process P61), the HMT controller 85 checks the “destination reference information” in the hash management table HMT corresponding to the hash functions #1 to #8 (in other words, the hash values #1 to #8) (processes P62 to P65).

For example, the HMT controller 85 sets the count value of the decrement counter to check the “destination reference information” to “n=8” according to the number of the hash values #1 to #8 to be checked (process P62).

The HMT controller 85 checks whether or not the flag information (e.g., bit) of the “destination reference information” for the hash value #8 is “1” (process P63). When the flag information is “0” (NO in process P63), the HMT controller 85 decrements the count value of the decrement counter (n=n−1) (process P64).

The HMT controller 85 checks whether or not the flag information of the “destination reference information” of the remaining hash values #7 to #1 is “1”, in descending order (NO in processes P65 and P63), until the count value becomes n=0 (until determined as YES in process P65). When the “destination reference priorities” of the hash functions #1 to #8 are set in ascending order, the check for the flag information may also be performed in ascending order.

When there is a “destination reference information” in which the flag information is “1” (YES in process P63), the HMT controller 85 selects the hash value Y=#n (process P67).

Then, the HMT controller 85 updates (for example, increments) the entry of the entry counter EMC corresponding to the selected hash value #n (process P68). In addition, the HMT controller 85 notifies the selected hash value #n to the FWT controller 86.

The FWT controller 86 updates the entry (for example, registers pointer information) of the forwarding table FWT corresponding to the notified selected hash value #n (process P69).

Meanwhile, when the count value of the decrement counter becomes n=0 (YES in process P65), it means that any of the hash values #1 to #8 is not selected.

In this case and the case where the entry counter EMC does not count the maximum value (NO in process P61), the HMT controller 85 selects the hash value #1 of the hash function Y=#1 tentatively (process P66).

Then, the HMT controller 85 updates the entry of the forwarding table FWT (for example, registers the pointer information), without updating the hash management table HMT (e.g., the entry counter EMC) (process P69).

(Hash Management Table Update Process)

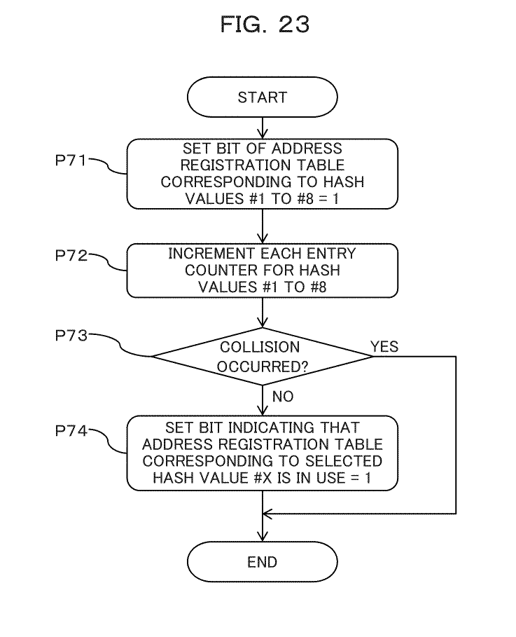

Next, an example of the process of updating the hash management table HMT, which is performed by the HMT controller 85, will be described with reference to FIG. 23.

As illustrated in FIG. 23, the HMT controller 85 sets the flag information (e.g., bit) of the “address registration information” corresponding to the hash value #n to “1” in the hash management table HMT in response to the registration request from the hash registration controller 87 (process P71).

In addition, the HMT controller 85 increments (+1) the count value of the entry counter EMC corresponding to the hash value #n for which the flag information is set to “1” (process P72).

Then, the HMT controller 85 checks whether or not a collision is occurred for the hash value #n (process P73). As a result of the check, when the collision is not occurred (NO in process P73), the HMT controller 85 sets the “use flag” in the “address registration information” corresponding to the selected hash value #X (see FIG. 20) to “1” indicating “in-use” (process P74).

Meanwhile, when the collision is occurred (YES in process P73), the setting of the “use flag” is not performed (in other words, the process P74 is bypassed) and the process may be finished.

(Exemplary Address Registration Release Process)

Next, an example of the address registration release process, which is performed by the forwarding processor 80, will be described with reference to FIG. 24. The “address registration release” may be referred to as “address deregistraion”. The forwarding processor 80 operates according to the flowchart illustrated in FIG. 24 to achieve the “entry release determination” process described above with reference to FIGS. 6 and 7.

The address registration release process may be performed by the cooperation of respective controllers 85 to 87 illustrated in FIG. 18. For example, the HMT controller 85 requests the hash calculator 84 to perform the hash calculation of the hash values #1 to #8 corresponding to the address information requested for releasing the registration, in response to a reception of a hash management table registration release request from the hash registration controller 87.

In response to the request, the hash calculator 84 calculates the hash values #1 to #8 corresponding to the address information requested for releasing the registration (hereinafter, may be referred to as “release target address”) by using the hash functions #1 to #8 (process P81). The calculated hash values #1 to #8 are provided to the HMT controller 85.

The HMT controller 85 in cooperation with the FWT controller 86 checks whether or not the hash values #1 to #8 can be released to update the hash management table HMT and the forwarding table FWT, in response to a reception of the registration release request from the hash registration controller 87.

For example, the HMT controller 85 sets the count value of the increment counter to check the entry to “n=8” according to the number of the hash values #1 to #8 to be checked (process P82).

Then, the HMT controller 85 subtracts 1 (i.e., −1) from the count of the entry counter EMC corresponding to the hash value #n (=#8) (process P83) and checks whether or not the subtraction result is “0” (process P84).

As a result of the check, when the subtraction result is 0 (YES in process P84), the HMT controller 85 initializes (for example, clears all to 0) the “address registration information” in the hash management table HMT corresponding to the hash value #n (process P85).

After that, the HMT controller 85 refers the entry of the forwarding table FWT corresponding to the hash value #n (process P86). When the subtraction result of the count value of the entry counter EMC is not “0” (NO in process P84), the HMT controller 85 may bypass the initialization process P85 and proceed to the process P86.

Then, the HMT controller 85 checks whether or not the registered address in the referred entry is matched with the release target address (process P87). When not matched (NO in process P87), the HMT controller 85 further checks whether or not the pointer information in the referred entry is “Null” (process P88).

When the pointer information is “Null” (YES in process P88), the entry in the forwarding table FWT corresponding to the release target address is not found. Thus, the HMT controller 85 may determine that the registration release fails (process P89). The determination result indicative of the registration release failure may be notified to the controller 13 of the transmission apparatus 1 or an external device by using error information or alarm information.

Meanwhile, when the pointer information in the referred entry is not “Null” (NO in process P88), the HMT controller 85 refers the entry in the forwarding table FWT corresponding to the pointer information (process P90).

Then, the HMT controller 85 searches the release target entry by tracing the pointer information in the referred entry until the entry of the forwarding table FWT registered the release target address is found (NO in process P87 and process P88).

When the entry registered the release target address is found (in the case of YES in process P87), the HMT controller 85 checks whether or not the referred entry is a head entry of the forwarding table FWT (process P91).

When the referred entry is not the head entry (NO in process P91), the HMT controller 85 updates the pointer information in the preceding entry with the pointer information in the referred entry (process P93). Therefore, it is possible to avoid the loss of the entry indicated by the pointer information.

Meanwhile, when the referred entry is the head entry (YES in process P91), the HMT controller 85 checks whether or not the pointer information in the head entry is “Null” (process P92).

When the pointer information in the head entry is not “Null” (NO in process P92), the HMT controller 85 copies the registration contents of the entry indicated by the pointer information to the head entry (process P94). Therefore, it is possible to avoid the loss of the entry indicated by the pointer information.

Meanwhile, when the pointer information of the head entry is “Null” (YES in process P92), the HMT controller 85 initializes the “destination reference information” and the “use flag” in the hash management table HMT corresponding to the hash value #n (process P95). The “initialization” may clear information to 0, for example.

After that, the HMT controller 85 subtracts the count value of the decrement counter to check the entry by 1 (n=n−1) (process P96) and checks whether or not n=0 is satisfied (process P97).

When n=0 is not satisfied (NO in process P97), the HMT controller 85 may repeat the processes subsequent to the process P83 until n=0 is satisfied (until YES is determined in process P97). When n=0 is satisfied (in the case of YES in process P97), the HMT controller 85 may finish the process.

As described above, it is checked whether or not the deregistration of the hash value #n is available, and the entries corresponding to the hash value #n available for the deregistration in the hash management table HMT and the forwarding table FWT are initialized. In this regard, even when the entries are initialized, the pointer information or the entry is updated such that the entry indicated by the pointer information is not lost. Therefore, appropriate destination reference can be maintained.

(Second Exemplary Configuration of Transmission Apparatus 1)

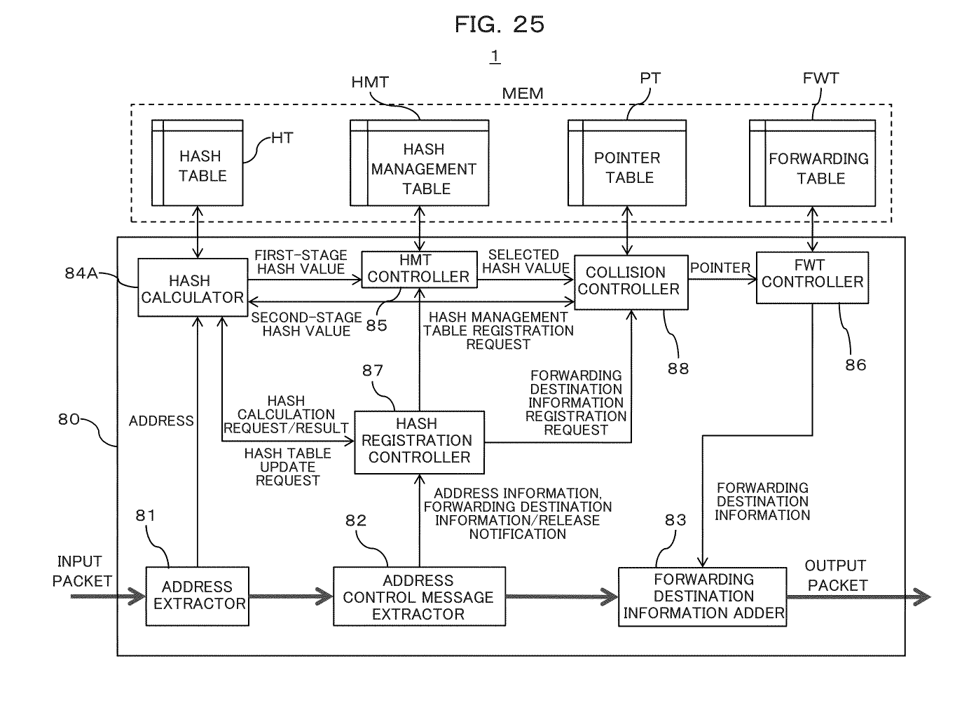

Next, a second exemplary configuration of the transmission apparatus 1 will be described with reference to FIG. 25. It may be considered that the second exemplary configuration corresponds to a functional configuration example operable to perform the processes illustrated in FIGS. 12 to 14. In FIG. 25. Parts to which the same reference numerals as those of FIG. 18 are assigned denote the same or similar parts above-described in FIG. 18 unless otherwise mentioned.

The transmission apparatus 1 of the second exemplary configuration illustrated in FIG. 25 differs from the first exemplary configuration illustrated in FIG. 18 in that a hash calculator 84A is provided instead of the hash calculator 84 and a collision controller 88 is further provided. In addition, the transmission apparatus 1 of the second exemplary configuration differs from the first exemplary configuration in that a hash table HT and a pointer table PT are additionally provided.

The collision controller 88 may be considered as constituting, together with the HMT controller 85 and the hash registration controller 87, an example of the above-described “hash controller”. In the second exemplary configuration, as in the first configuration example, an entry counter EMC may be included in the hash management table HMT. In addition, each of the blocks 81 to 83, 84A, and 85 to 88 illustrated in FIG. 25 may be considered as being a component of the forwarding processor 80.

The hash table HT, the hash management table HMT (may include the entry counter EMC), the pointer table PT, and the forwarding table FWT may be stored in a memory MEM that is an example of a storage device or a storage medium. These tables (in other words, data) may be stored in different storage regions of the single memory MEM, or may be stored in distributed storage regions of a plurality of different memories MEM.

The hash calculator 84A is operable to perform the hash calculation by the multi-stage hash function illustrated in FIGS. 12 to 14. The hash calculator 84A may be considered as corresponding to the above-described hash function searcher HFS or having a function which serves as the hash function searcher HFS.

For example, the hash calculator 84A calculates a first-stage hash value by a first-stage hash function for the address information extracted by the address extractor 81. In addition, the hash calculator 84A calculates a second-stage hash value by a second hash function.

The second-stage hash value may be calculated by inputting the first-stage hash value to the second hash function, or may be calculated by inputting the address information to the second hash function. In the latter case, the first and second hash values may be calculated in parallel.

As illustrated in FIG. 12, the second-stage hash function can be set and registered in the hash table HT. As illustrated in FIG. 13, a plurality of second-stage hash functions (for example, the hash functions Fa, Fb, and Fc) may be set and registered in the hash table HT.

The first-stage hash value calculated by the first-stage hash function may be provided to the HMT controller 85, for example. The second-stage hash value obtained by the second-stage hash function may be provided to the collision controller 88, for example. Even when a collision is occurred in the first-stage hash value, it is possible to register a plurality of address information by using the second-stage hash value.

At the time of the destination reference, the collision controller 88 obtains the pointer information to the forwarding table FWT with reference to the pointer table PT, based on the (first-stage) hash value and the second-stage hash value which are selected by the HMT controller 85. The obtained pointer information may be provided to the FWT controller 86, and the FWT controller 86 refers the entry of the forwarding table FWT indicated by the corresponding pointer information.

The collision controller 88 manages free pointer information, and at the time of the address registration, assigns any one of the free pointer information to the second-stage hash value to set and register the assigned pointer information to the pointer table PT (see, for example, FIG. 12). The assigned pointer information may be provided to the FWT controller 86, and the FWT controller 86 registers the pointer information to the forwarding table FWT.

When a collision is occurred in the second hash value, the collision controller 88 may request the hash calculator 84A to search the second-stage hash function available to obtain a non-colliding second-stage hash value.

In response to the request, the hash calculator 84A may search or set (or update) the second-stage hash function available to obtain the non-colliding hash value in the hash table HT, and may recalculate the second-stage hash value not causing a collision. The recalculated hash value may be provided to the collision controller 88.

The collision controller 88 assigns the free pointer information to the second-stage hash value received from the hash calculator 84A to update the pointer table PT.

As illustrated in FIG. 14, the hash calculator 84A may switch the first-stage hash function between the two new and old hash functions. In response to the switching of the first-stage hash function, the hash table HT and the pointer table PT may be updated.

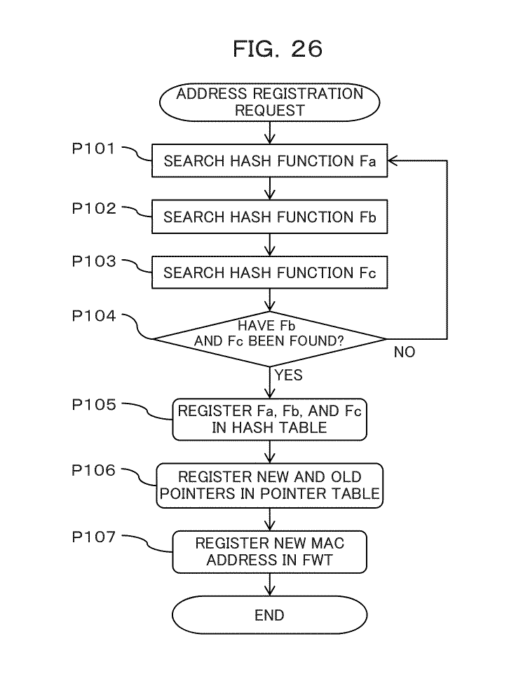

Next, an exemplary operation of the transmission apparatus 1 (for example, the forwarding processor 80) of the second exemplary configuration described above will be described with reference to FIGS. 26 to 29.

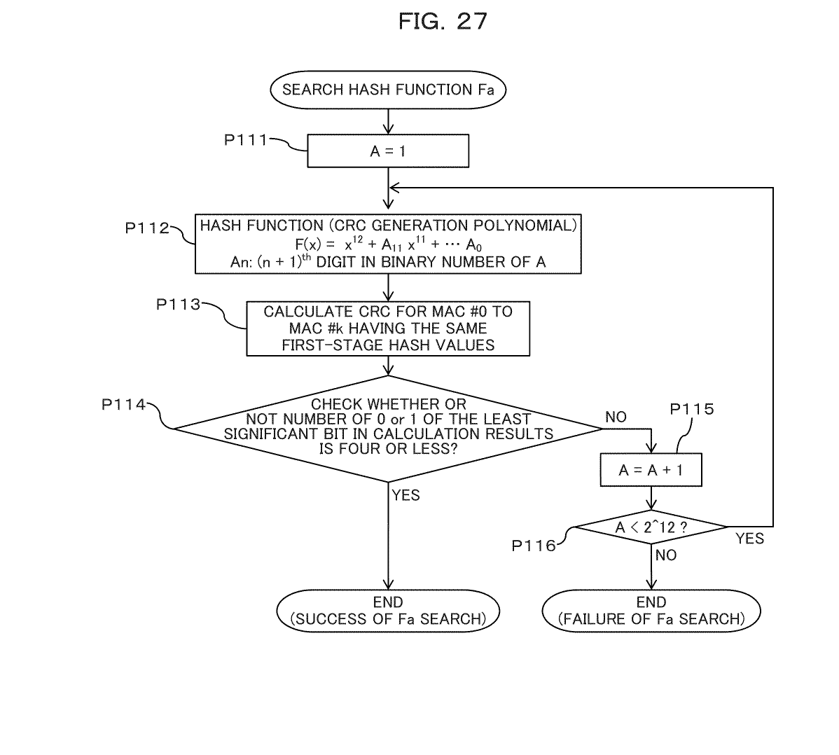

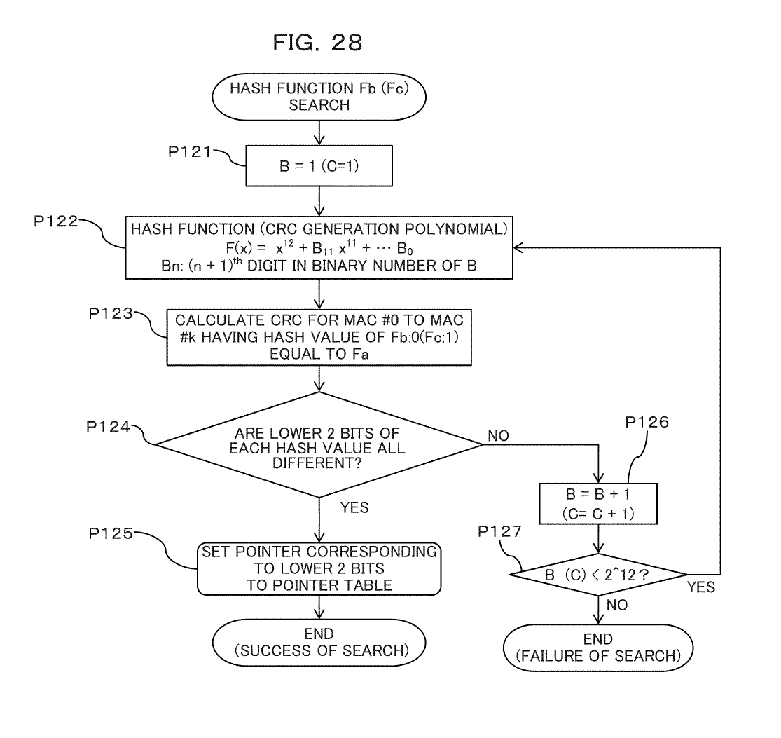

FIG. 26 is a flowchart illustrating an example of the address registration process in response to a registration request of new address information (for example, MAC address). FIGS. 27 and 28 are flowcharts illustrating an exemplary search process of the second-stage hash function.

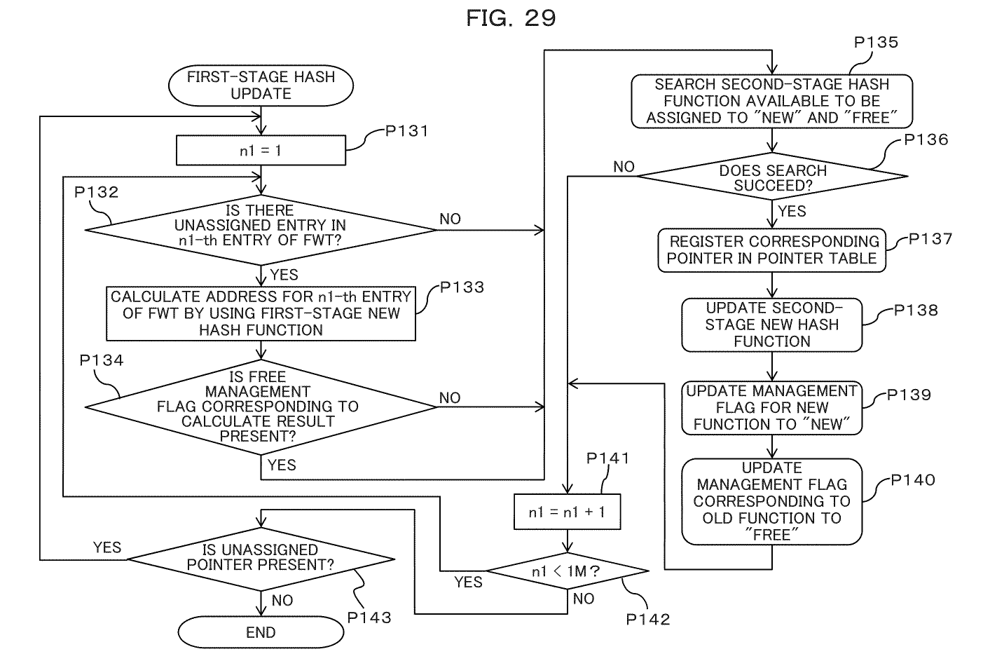

FIG. 29 is a flowchart illustrating an example of the update process of the first-stage hash function. In FIGS. 26 to 28 illustrates, as in FIG. 13, a case where three hash functions Fa, Fb, and Fc are used as the plurality of second-stage hash functions.

For example, in FIGS. 27 and 28, a case where maximum eight collisions are allowed by using CRC12 in each of the three second-stage hash functions Fa, Fb, and Fc. In other words, as illustrated in FIG. 13, the hash values are distributed to two groups by using the hash function Fa, and the distributed hash values of two groups are further distributed to four hash values by using the two hash functions Fb and Fc.

(Address Registration Process)

In the forwarding processor 80 illustrated in FIG. 25, when the address information to be registered is provided from the address control message extractor 82 to the hash registration controller 87, the hash registration controller 87 transmits an update request of the hash table HT to the hash calculator 84A.

In response to the update request, as illustrated in FIG. 26, the hash calculator 84A searches the hash functions Fa, Fb, and Fc (processes P101 to P103), and checks whether or not the hash functions Fb and Fc are successfully searched (process P104).

When the search of the hash functions Fb and Fc fails (NO in process P104), the hash calculator 84A repeats the search of the hash functions Fa, Fb, and Fc until the hash functions Fb and Fc are successfully found (until YES in process P104).

When the hash functions Fa, Fb, and Fc are successfully searched (in the case of YES in process P104), the hash calculator 84A registers the second-stage hash functions Fa, Fb, and Fc to the hash table HT (process P105).

In addition, the hash calculator 84A provides the collision controller 88 with the second-stage hash values obtained by the hash functions Fa, Fb, and Fc. The collision controller 88 registers the pointer information to the forwarding table FWT, which corresponds to each of the second-stage hash values, in the pointer table PT (process P106).

Meanwhile, the FWT controller 86 registers the new address information (for example, the MAC address) in the forwarding table FWT in response to a forwarding destination information registration request received from the hash registration controller 87 (process P107). The entry in which the new address information is registered is indicated (in other words, pointed) by the pointer information registered in the pointer table PT.

(Hash Function Search Process)

Next, an example of the search process P101 to P103 of the hash functions Fa, Fb, and Fc illustrated in FIG. 26 will be described with reference to FIGS. 27 and 28. FIG. 27 is a flowchart illustrating an example of the search process of the hash function Fa. FIG. 28 is a flowchart illustrating an example of the search process of the hash function Fb (or Fc).

FIG. 27 illustrates an example in which the hash function Fa(x) is a generation polynomial of the CRC12, which is expressed by the following Formula (1).

Fa(x)=x¹²+A₁₁x¹¹+ . . . A₁x+A₀ (1)

In Formula (1), “Aj” represents a (j+1)^{th} digit in a binary number of a natural number “A”.

FIG. 28 illustrates an example in which the hash functions Fb(x) and Fc(x) are generation polynomials of the CRC12, which are expressed by the following Formulas (2) and (3).

Fb(x)=x¹²+B₁₁x¹¹+ . . . B₁x+B₀ (2)

Fc(x)=x¹²+C₁₁x¹¹+ . . . C₁x+C₀ (3)

In Formula (2), “Bj” represents a (j+1)^{th} digit in a binary number of a natural number “B”. In Formula (3), “Cj” represents a (j+1)^{th} digit in a binary number of a natural number “C”.

(Exemplary Search Process of Hash Function Fa)

As illustrated in FIG. 27, the hash calculator 84A sets the coefficient A of Formula (1) to A=1 to generate the hash function Fa(x) that is the polynomial of the CRC12 (processes P111 and P112).

Then, the hash calculator 84A performs a CRC calculation by Formula (1) for the address information (for example, MAC#0 to MAC#k: k is an integer equal to or greater than 0) for which a collision is occurred in the first-stage hash value (process P113).

Further, the hash calculator 84A checks whether or not the number of the same least significant bits of “0” or “1” in the calculation result (in other words, hash value) for each of MAC#0 to MAC#k is equal to or less than a threshold value (for example, 4) (process P114).

In other words, the hash calculator 84A checks whether or not the number of collisions in the hash values obtained for each of MAC#0 to MAC#k is equal to or less than the threshold value.

When the number of collisions is equal to or less than the threshold value (YES in process P114), the hash calculator 84A may determine that the hash function Fa(x) with the coefficient A=1 is successfully searched and may finish the search process.

Meanwhile, when the number of collisions exceeds the threshold value (NO in process P114), the hash calculator 84A proceeds with searching the hash function Fa(x) available to obtain a calculation result equal to or less than the threshold value, while incrementing the coefficient A (A=A+1) in the range where A<2¹² is satisfied.

The above search process corresponds to a process from NO in the process P114 to the process P115 and a process from YES in the process P116 to the processes P112 to P114.

When the hash function Fa(x) available to obtain the calculation result equal to or less than the threshold value is successfully searched (YES in process P114), the hash calculator 84A may finish the search process.

When the hash function Fa(x) of which the number of collisions is equal to or less than the threshold value is not successfully found even though the incremented coefficient A reaches A=2¹² (NO in process P116), the hash calculator 84A may determine that the search is failed and may finish the search process. The failure of the search may be notified to the controller 13 of the transmission apparatus 1 or an external device by using error information or alarm information.

(Exemplary Search Process of Hash Function Fb (or Fc))

In the example illustrated in FIG. 28, the hash calculator 84A sets the coefficient B of Formula (2) to B=1 to generate the hash function Fb(x) that is the polynomial of the CRC12 (processes P121 and P122). The search process using the hash function Fc(x) represented by Formula (3) may correspond to the search process in which the coefficient B in FIG. 28 is read as the coefficient C.

Then, the hash calculator 84A performs the CRC calculation by Formula (2) for the address information (for example, MAC#0 to MAC#k) for which the first-stage hash value is “0” (process P123).

In the search process of the hash function Fc(x), the hash calculator 84A may perform the CRC calculation by Formula (3) for the address information for which the first-stage hash value is “1”.

However, contrary to the above example, the CRC calculation using the hash function Fc(x) of Formula (3) may be performed for the address information for which the first-stage hash value is “1”, and the CRC calculation using the hash function Fb(x) of Formula (2) may be performed for the address information for which the first-stage hash value is “0”.

Then, the hash calculator 84A checks whether or not the lower 2 bits of the calculation result are all different for each of MAC#0 to MAC#k (process P124).

In other words, the hash calculator 84A checks whether or not the hash value (0 or 1) obtained for each of MAC#0 to MAC#k can be distributed to four hash values that can be expressed by 2 bits (process P124).

When the lower 2 bits of the hash value are all different (YES in process P124), the hash calculator 84A sets and registers the pointer information corresponding to the lower 2 bits of the hash value obtained by the hash function Fb(x) in the pointer table PT (process P125).

The same is applied to the hash value obtained by the hash function Fc(x). Thereby, the hash calculator 84A may determine that the hash function Fb(x) and Fc(x) are successfully searched and may finish the search process.

Meanwhile, in the process P124, when the calculation result in which the lower 2 bits of the hash value are same is present (NO in process P124), the hash calculator 84A may search the hash function Fb(x) (and Fc(x)) again.

For example, the hash calculator 84A proceeds with searching the hash function of which the lower 2 bits of the hash value are all different (YES in process P124), while incrementing the coefficient B (or C) in the range satisfying B<2¹² (or C<2¹²).

The search process corresponds to a process from NO in the process P124 to the process P126 and a process from YES in the process P127 to the processes P122 to P124.

Finally, when the hash function of which the lower 2 bits of the hash value are all different is successfully searched (YES in process P124), the hash calculator 84A may perform the above-described pointer registration process P125 and finish the search process.

When the hash function satisfying the condition in the process P124 even though the coefficient B (or C) is incremented to B=2¹² 2 (or C=2¹²) (NO in process P127), the hash calculator 84A may determine that the search is failed and may finish the search process. The failure of the search may be notified to the controller 13 of the transmission apparatus 1 or an external device by using error information or alarm information.

At the time of address deregistration, the collision controller 88 may update the pointer information in the pointer table PT to “unused” and may notify (may also be referred to as “return”) the unused pointer information to the hash calculator 84A.

(Exemplary First-stage Hash Function Update Process)

Next, an exemplary process of updating the first-stage hash function, which is performed by the forwarding processor 80 illustrated in FIG. 25, will be described with reference to FIG. 29. The forwarding processor 80 operates according to the flowcharts illustrated in FIG. 29 to achieve the “hash function update process” illustrated in FIG. 14.

First, in the forwarding processor 80, the hash calculator 84A sets the count value n1 of the increment counter to check the entry of the forwarding table FWT to n1=1, for example (process P131).

“n1” is, for example, an integer that is equal to or greater than 1 and is equal to or less than the maximum number of entries (for example, 1 M) in the forwarding table FWT.

The hash calculator 84A inquires, to the FWT controller 86 through the collision controller 88, whether or not the n1^{th} entry in the forwarding table FWT is free (in other words, unassigned) (process P132).

As a result of the inquiry, when the n1^{th} entry of the forwarding table FWT is free (YES in process P132), the hash calculator 84A calculates input address information (for example, MAC address) by using the first-stage new hash function (process P133).

Then, the hash calculator 84A checks whether or not the “management flag” corresponding to the calculation result which is the first-stage new hash value (see FIG. 14) is free in the hash table HT (process P134).

When the “management flag” is free (YES in process P134), the hash calculator 84A searches the “second-stage hash function” that can be assigned to “new” and “free” of the “management flag” (process P135).

When the “second-stage hash function” is successfully searched (YES in process P136), the hash calculator 84A requests the HMT controller 85 to update the pointer information corresponding to the searched “second-stage hash function” (in other words, second-stage hash value).

In response to the update request of the pointer information, the HMT controller 85 registers the pointer information corresponding to the second-stage new hash value to the pointer table PT (process P137) and returns a response to the hash calculator 84A.

In response to the response, the hash calculator 84A updates the “second-stage hash function” with the new hash function which is successfully searched, in the hash table HT (see FIG. 14) (process P138), and updates the “management flag” for the new hash function to “new” (process P139).

In addition, the hash calculator 84A updates the “management flag” corresponding to the second-stage old hash function to “free” in the hash table HT (see FIG. 14) (process P140).

The order of the processes P138 to P140 may be exchangeable. Alternatively, the processes P138 to P140 may be performed in parallel.

After the processes P138 to P140, the hash calculator 84A increments the count value n1 of the increment counter by 1 (i.e., n1=n1+1) (process P141), and checks whether or not the count value n1 is less than the number of 1 M entries (process P142).

When “NO” is determined in each of the process P132, the process P134, and the process P136, the process P141 and the process P142 may be performed.

When the count value n1 is less than the number of 1 M entries (YES in process P142), the hash calculator 84A may return to the process P132 to perform the processes P132 to P140 on the next entry in the forwarding table FWT.

The hash calculator 84A may repeat the processes P132 to P140 until n1=1 M is satisfied (until NO in process P142), while incrementing the count value n1 (process P141).

Thereby, the update process of the “first-stage hash function” and the “second-stage hash function” is performed on all of the entries in the forwarding table FWT.

Then, the hash calculator 84A checks whether or not the pointer information being unregistered (in other words, unassigned) in the hash table HT in the process P137 is present (process P143).

When the unassigned pointer information is present (YES in process P143), the hash calculator 84A initializes the count value n1 of the increment counter to “1” and tries to register the pointer information (process P132 to P142).

Finally, when all of the pointer information is successfully assigned (NO in process P143), the hash calculator 84A may finish the update process.

As described above, the update process of the hash function illustrated in FIG. 14 can be achieved. In the example of FIG. 29, the search for the free entry is sequentially performed from the head entry in the forwarding table, but the search order may be changed. For example, the search may be sequentially performed from the entry corresponding to the hash value for which many collisions are occurred.

(Implementation Example of Forwarding Processor 80 in Transmission Apparatus 1)

The function serving as the forwarding processor 80 illustrated in FIG. 18 or FIG. 25 may be implemented in the transmission apparatus 1 by using a hardware circuit or by using a software process.

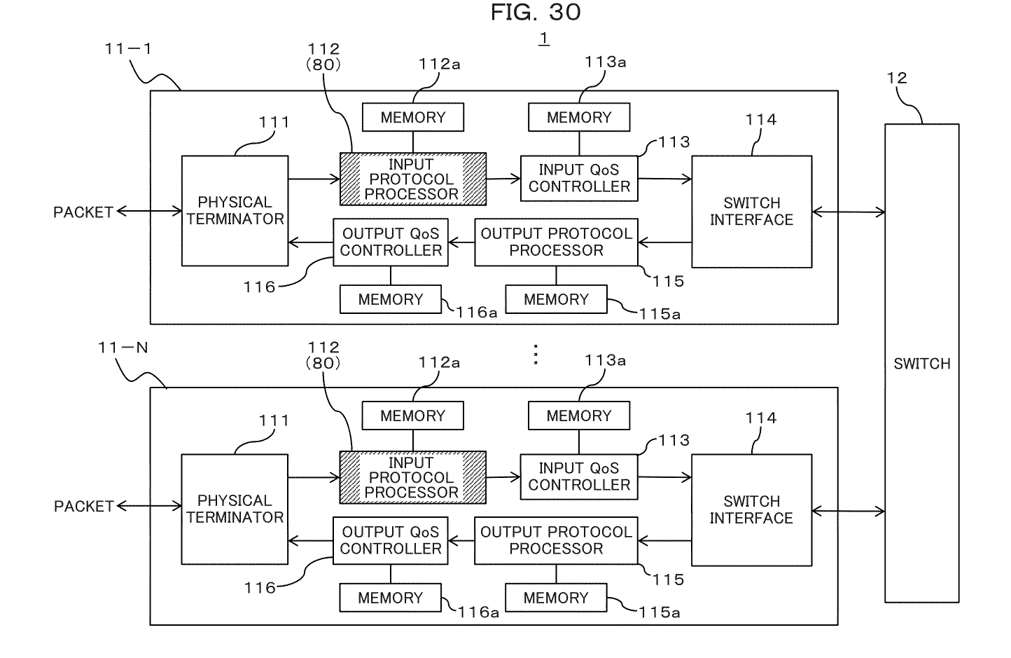

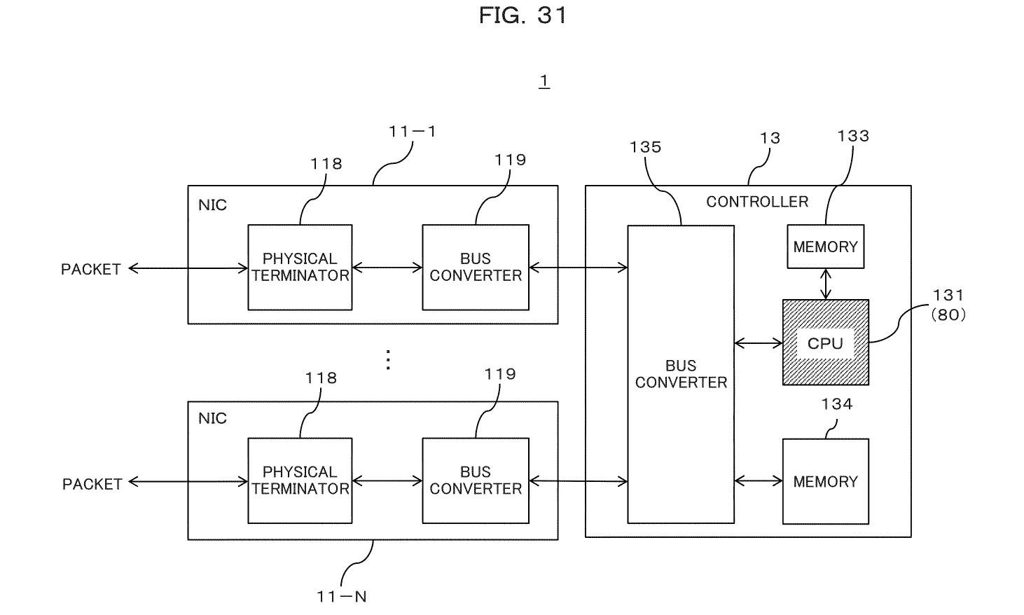

FIG. 30 illustrates a case where the function serving as the forwarding processor 80 is implemented in the transmission apparatus 1 by the hardware circuit. FIG. 31 illustrates a case where the function serving as the forwarding processor 80 is implemented in the transmission apparatus 1 by the software process.

(Hardware Implementation)

The function serving as the forwarding processor 80 may be implemented in each of the input-output IFs 11 of the packet transmission apparatus 1 illustrated in FIG. 1. In the example of FIG. 30, the function serving as the forwarding processor 80 is implemented in the input protocol processor 112 of each of the input-output IFs 11.

Here, an exemplary configuration of the input-output IF 11 will be described. The input-output IF 11 includes, for example, a physical terminator 111, an input protocol processor 112, a memory 112a, an input QoS controller 113, a memory 113a, and a switch interface 114. In addition, the input-output IF 11 includes, for example, an output protocol processor 115, a memory 115a, an output QoS controller 116, and a memory 116a.

The physical terminator 111 performs physical layer process on an input packet and an output packet. Examples of the physical layer process may include a termination (in other words, analysis) process for an input packet header or an addition process of packet header to an output packet.

The input protocol processor 112 performs a protocol process corresponding to a communication protocol of an upper layer than a physical layer for the input packet on which the header termination process is performed by the physical terminator 111. The forwarding processor 80 illustrated in FIG. 18 or FIG. 25 may be implemented in the input protocol processor 112.

The memory 112a stores, for example, data that is used for the protocol process performed by the input protocol processor 112. The data may include the hash management table HMT (may include the entry counter EMC), the forwarding table FWT, the hash table HT, and the pointer table PT, and the like.

The input QoS controller 113 performs a quality of service (QoS) control for the packet on which the protocol process is performed by the input protocol processor 112. An example of the QoS control may be to control the output order or the output rate of the packets according to the priority corresponding to the type of the packet or the reserved communication bandwidth.

The memory 113a stores, for example, data that is used for the QoS control performed by the input QoS controller 113.

The switch interface 114 is a connection interface between the input QoS controller 113 and the output protocol processor 115, and the SWF 12. For example, the switch interface 114 outputs the packet which is subjected to the QoS control by the input QoS controller 113 to the SWF 12, and outputs the packet input from the SWF 12 to the output protocol processor 115.

The output protocol processor 115 performs a protocol process corresponding to a communication protocol of an upper layer than a physical layer for the packet input from the switch interface 114.

The memory 115a stores, for example, data that is used for the protocol process performed by the output protocol processor 115.

The output QoS controller 116 performs a QoS control for the packet on which the protocol process is performed by the output protocol processor 115.

The memory 115a may store, for example, data that is used for the protocol process performed by the output protocol processor 115.

The memories 112a, 113a, 115a, and 116a are all an example of a storage device or a storage medium, and may be a RAM or an HDD. In addition, in the example of FIG. 30, each of the memories 112a, 113a, 115a, and 116a is an individual memory for each of the blocks 112, 113, 115, and 116, but all or part thereof may be a shared memory.

Each of the input-output IFs 11 illustrated in FIG. 30 may be implemented by using a semiconductor integrated circuit that is an example of a hardware circuit. Examples of the semiconductor integrated circuit may include an integrated circuit (IC), a large scale integration (LSI), a field programmable gate array (FPGA), and an application specific integrated circuit (ASIC).

(Software Implementation)

As described above, the function serving as the forwarding processor 80 may be implemented in the transmission apparatus 1 as the software process performed or generated by the CPU 131 of the controller 13 as illustrated in FIG. 31.

For example, the CPU 131 may read out the software (may also be referred to as program) or data, which implements the function serving as the forwarding processor 80, from the memory 133 or 134 to thereby implement the function serving as the forwarding processor 80. The memories 133 and 134 may correspond to the memory 132 illustrated in FIG. 1.

The memory 133 may be a cache memory, and the memory 134 may be a storage device or a storage medium such as a RAM or an HDD. The program or the data stored in the memory 134 is read by the CPU 131 and is loaded on the cache memory 133. The CPU 131 reads the program or data loaded on the cache memory 133 and operates according to the read program or data to implement the process corresponding to the read program or data.

The CPU 131 and the memory 134 may be connected to a bus converter 135 through a bus. The bus converter 135 is an example of a connection interface between the bus converters 119 provided in each of the input-output IFs 11. In FIG. 31, “NIC” is an abbreviation of “Network Interface Card” and is an example of the input-output IF 11.

When the bus communication specification or the protocol is different between the input/output IF 11 and the controller 13, the bus converters 119 and 135 convert input and output signals so that the bus communication is appropriately performed therebetween.

Each of the input-output IFs 11 may include a physical terminator 118 that is identical or similar to the physical terminator 111 illustrated in FIG. 30.

In the configuration of FIG. 31, the input and output protocol processes or the QoS control described with reference to FIG. 30 may also be considered as being implemented by the CPU 131 in conjunction with the forwarding process.

As described above, the function serving as the forwarding processor 80 is not limited to the case where a high-speed process is achieved by using the hardware circuit. It is possible to obtain advantageous technical effects in the case where the processing capacity of the forwarding processor 80 is improved by the software process.

According to the above-described technology, it is possible to suppress the deterioration in the forwarding performance of the transmission apparatus.

(Others)

The applications of the above-described embodiments are not limited to the transmission apparatus such as the packet transmission apparatus. For example, the above-described embodiments may be applied to an information processing apparatus that performs database reference (in other words, search). Examples of the information processing apparatus may include a personal computer (PC), a server computer, a cloud computer, and the like.

In other words, the information (or data) to be referred (or searched) is not limited to the above-described forwarding table FWT, and may be a database (DB) in which information or data corresponding identification information of input data is registered.

For example, in the information processing apparatus that searches a DB by using the identification information of the input data as a search key, the process in the above-described embodiments may be applied by degenerating the identification information using the plurality of hash functions.

In this case, the probability of collision in the hash values can be reduced as described in the embodiments above. Even when the collision is occurred in the hash values with low probability, it is possible to suppress an increase in the number of times of reference (in other words, access) to the DB, while minimizing an increase in the size of the DB. Therefore, it is possible to prevent the deterioration in the information search performance of the information processing apparatus.

All examples and conditional language provided herein are intended for pedagogical purposes to aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiment(s) of the present invention have been described in detail, it should be understood that the various changes, substitutions, and alterations could be made hereto without departing from the spirit and scope of the invention.

What is claimed is:

1. A transmission apparatus comprising:
a hash calculator configured to obtain a plurality of hash values by using a plurality of hash functions based on identification information of input data;
a forwarding controller configured to control a forwarding of the input data with reference to forwarding information based on any one of the hash values; and
a hash controller configured to control a selection of a hash value to be used for the reference based on hash management information, the hash management information indicating whether or not each of the hash values is in-use to refer the forwarding information for each hash function.

2. The transmission apparatus according to claim 1, wherein the hash management information includes information indicating whether or not the hash values calculated by the hash functions regardless of the use or non-use are registered for each of the hash functions, and
the hash controller is configured to determine whether or not a hash value obtained by the hash calculator with respect to identification information of new input data is allowed to be registered in the hash management information, based on the information indicating the presence or absence of the registration.

3. The transmission apparatus according to claim 2, wherein the hash controller is configured to assign selection priorities of the registration to the plurality of hash functions, and to control the selection in order of priorities reverse to the selection priorities.

4. The transmission apparatus according to claim 2, wherein, for all of unused hash values, when hash values obtained by the same hash function are in a collision at the time of the registration, the hash controller determines that the hash values in the collision obtained by the same hash function are unavailable to be registered.

5. The transmission apparatus according to claim 2, wherein, for the in-use hash values, when hash values obtained by the same hash function are in a collision at the time of the registration, the hash controller determines that a hash value obtained by a hash function assigned with a higher priority than that of the same hash function is unavailable to be registered.

6. The transmission apparatus according to claim 1, wherein the hash controller counts the number of registrations of the hash values in the hash management information for each of the identification information, and
when a count value becomes 0, the hash controller initializes the hash management information corresponding to the hash value for the identification information.

7. The management apparatus according to claim 1, wherein the forwarding information includes pointer information pointing forwarding information in a next reference destination when a collision is occurred in the selection of the hash value.

8. The transmission apparatus according to claim 1, wherein the plurality of hash functions includes a first hash function to obtain a first hash value, and a second hash function to obtain a second hash value which is not in collision with the first hash value, and the hash controller refers to the forwarding information based on pointer information, the pointer information pointing the forwarding information based on the first hash value and the second hash value.

9. The transmission apparatus according to claim 8, wherein the second hash function is plural, and
the hash controller groups the pointer information according to a plurality of second hash values obtained by the plurality of second hash functions.

10. The transmission apparatus according to claim 8, wherein, when the first hash function is updated to another first hash function available to obtain hash values in a smaller deviation than that of the pre-updated first hash function, the hash controller updates the pointer information according to the update.

11. A forwarding control method comprising:
obtaining a plurality of hash values by using a plurality of hash functions based on identification information of input data;
controlling a forwarding of the input data with reference to forwarding information based on any one of the hash values; and
controlling a selection of a hash value to be used for the reference based on hash management information, the hash management information indicating whether or not each of the hash values is in-use to refer the forwarding information for each hash function.

12. An information processing apparatus comprising:
a hash calculator configured to obtain a plurality of hash values by using a plurality of hash functions based on identification information of input data;
an information searcher configured to search information corresponding to the input data with reference to a database in which information corresponding to the identification information is registered based on any one of the hash values; and
a hash controller configured to control a selection of a hash value to be used for the reference based on hash management information, the hash management information indicating whether or not each of the hash values is in-use to refer the database for each hash function.
